(19) United States
(12) Patent Application Publication
(10) Pub. No.: US 2023/0183588 A1
(43) Pub. Date: Jun. 15, 2023

(54) Treatment of Sour Natural Gas

(71) Applicant: Saudi Arabian Oil Company, Dhahran (SA)

(72) Inventors: Mohammad S. Al-Qahtani, Dhahran (SA); Seung-Hak Choi, Dhahran (SA); Sebastien A. Duval, Dhahran (SA)

(21) Appl. No.: 17/549,378

(22) Filed: Dec. 13, 2021

(51) Int. Cl. C10L 3/10; E21B 43/34; C01B 17/04; C01B 3/04; B01J 19/08; C01B 32/40; C01B 3/34

(52) U.S. Cl. CPC C10L 3/104; E21B 43/34; C10L 3/103; C01B 17/0495; C01B 3/04; B01J 19/088; C01B 32/40; C01B 3/342; C10L 2290/02; C01B 2203/0277; C01B 2203/0283; C01B 2203/0861; C01B 2203/84; C01B 2203/86

(57) ABSTRACT

A system and method for treating natural gas, including producing natural gas from a subterranean formation via a wellhead system to a nonthermal plasma (NTP) catalytic unit, converting by the NTP unit carbon dioxide (CO₂) and hydrogen sulfide (H₂S) in the natural gas into carbon monoxide (CO), elemental sulfur (S), and hydrogen (H₂), and removing the elemental sulfur as liquid elemental sulfur to give treated natural gas. The NTP unit may convert methane (CH₄) in the natural gas to heavier hydrocarbons.

### TECHNICAL FIELD

This disclosure relates to plasma treatment (e.g., catalytic plasma treatment) of natural gas that may have acid gas, such as hydrogen sulfide or carbon dioxide, or both.

### BACKGROUND

Sour natural gas may be natural gas that contains modest or significant amounts of hydrogen sulfide (H₂S). Processing of sour natural gas to remove H₂S can be relatively expensive. For natural gas with high H₂S content, processing to remove the H₂S may be cost prohibitive. Moreover, sour natural gas may additionally include carbon dioxide. Carbon dioxide (CO₂) is the primary greenhouse gas emitted through human activities. The conversion of CO₂ may beneficially reduce CO₂ emissions.

### SUMMARY

An aspect relates to a method of treating natural gas, including producing natural gas from a subterranean formation through a wellbore to a wellhead and discharging the natural gas from the wellhead via an inlet conduit to a nonthermal plasma (NTP) unit having a NTP reactor and a catalyst. The method includes converting, via the NTP unit, carbon dioxide (CO₂) in the natural gas into carbon monoxide (CO). The method includes converting, via the NTP unit, hydrogen sulfide (H₂S) in the natural gas into elemental sulfur (S) and hydrogen (H₂), and removing the elemental sulfur as liquid elemental sulfur to give treated natural gas. The method includes discharging the treated natural gas from the NTP unit via an outlet conduit.

Another aspect relates to a method of treating sour natural gas, including producing natural gas from a subterranean formation through a wellbore and a wellhead to a NTP catalytic unit having a NTP reactor and a catalyst, wherein the natural gas has at least 20 volume percent (vol %) of acid gas including CO₂ and H₂S. The method includes converting, by the NTP catalytic unit, CO₂ in the natural gas by dissociation reaction of CO₂ into CO and oxygen (O₂). The method includes converting, by the NTP catalytic unit, H₂S in the natural gas by dissociation reaction of H₂S into elemental sulfur (S) and H₂. The method includes removing the elemental sulfur as liquid elemental sulfur to give treated natural gas having less than 10 vol % of acid gas.

Yet another aspect relates to a method of treating natural gas, including producing natural gas from a subterranean formation through a wellhead and through a NTP system downstream of the wellhead, the NTP system having a NTP reactor and a catalyst, wherein the natural gas flows from the wellhead via an inlet conduit to the NTP system. The method includes converting, via the NTP system, CO₂ in the natural gas into CO and oxygen O₂. The method includes converting, via the NTP system, H₂S in the natural gas into elemental sulfur (S) and H₂. The method includes removing, via the NTP system, the elemental sulfur from the natural gas to give treated natural gas, and discharging the treated natural gas from the NTP system via a discharge conduit to a user.

Yet another aspect is a method of treating sour natural gas, including discharging natural gas from a wellhead system coupled to a wellbore through which the natural gas is produced from a subterranean formation, wherein the natural gas has at least 20 vol % of acid gas. The method includes converting carbon dioxide in the natural gas into carbon monoxide and oxygen via NTP catalysis in fluid communication with the wellhead system. The method includes converting hydrogen sulfide in the natural gas as received from the wellhead system into elemental sulfur and hydrogen via the NTP catalysis. The method includes removing the elemental sulfur from the natural gas to discharge treated natural gas to a user, wherein discharging the natural gas from the wellhead system, converting the carbon dioxide and the hydrogen sulfide, and removing the elemental sulfur are collectively a continuous operation.

The details of one or more implementations are set forth in the accompanying drawings and the description below. Other features and advantages will be apparent from the description and drawings, and from the claims.

### BRIEF DESCRIPTION OF DRAWINGS

FIG. 1 is a diagram of a system for producing natural gas.

FIG. 2 is a diagram of a nonthermal plasma (NTP) catalytic unit.

FIG. 3 is a diagram of a system having a NTP catalytic unit and a gas sweetening unit.

FIG. 4 is a diagram of a system including a sour natural gas well, a mobile NTP catalytic unit, and a flare.

FIG. 5 is a diagram of representations of three common NTP types.

FIGS. 6-8 are diagrams of a representation of an approximate cross-section of an NTP reactor that is a dielectric barrier discharge (DBD) packed-bed reactor.

FIG. 9 is a diagram of a simplified representation of an NTP reactor that is a DBD reactor.

FIGS. 10-11 are diagrams of a NTP corona reactor.

FIG. 12 is a diagram of a NTP gliding arc reactor.

FIG. 13 is a diagram of a boiler system including a boiler for power generation.

FIG. 14 is a diagram of a Brayton-Rankine combined cycle.

FIG. 15 is a diagram of an example of a heat recovery steam generator (HRSG).

FIG. 16 is a diagram of a well site having a wellhead and a flare system.

FIG. 17 is a diagram of a gas sweetening system.

FIG. 18 is a diagram of a contactor column (absorber column) that dehydrates natural gas with a liquid desiccant, such as glycol.

FIG. 19 is a method of treating sour natural gas.

Like reference numbers and designations in the various drawings indicate like elements.

### DETAILED DESCRIPTION

Some aspects of the present disclosure are directed to processing methane (CH₄) gas streams having hydrogen sulfide (H₂S) and carbon dioxide (CO₂). The combined amount of H₂S and CO₂ in the CH₄ stream may be at least 20 volume percent (vol %), or can be less than 20 vol %. Embodiments relate to employing a nonthermal plasma (NTP) technique with solid catalytic material(s) to fully or partially treat (convert) H₂S, CO₂, and CH₄ in the CH₄ stream to produce hydrogen (H₂), sulfur (S), carbon monoxide (CO), and hydrocarbons in a single or multi-stage process or system.

Some aspects relate to NTP catalytic treatment of a CH₄ stream having high acid gas (H₂S and CO₂), such as at least 20 vol % of acid gas, or at least 30 vol % of acid gas. Again, however, the NTP catalytic treatment can be applied to CH₄ streams having less than 20 vol % of acid gas. In operation, the plasma (NTP) in the plasma catalytic unit is the CH₄ stream (e.g., sour natural gas) as excited in its plasma state (NTP state). The NTP catalytic treatment may reduce the acid gas content of the natural gas to less than 10 vol %. The NTP catalytic treatment may convert (decompose) all or substantially all of the H₂S in the natural gas into H₂ and elemental sulfur, giving the treated natural gas as having, for example, less than 100 part per million by volume (ppmv) of H₂S in some embodiments.

The NTP reactor may be a dielectric barrier discharge (DBD) reactor or other NTP reactor type (e.g., corona discharge). The treatment (e.g., at less than 200° C., less than 250° C., or less than 300° C.) partially or fully converts the H₂S and CO₂ into H₂, elemental S, and CO. The elemental S may condense and be removed as liquid. Some of the CH₄ may be converted via the NTP catalysis into H₂ and C₂₊ hydrocarbons. The C₂₊ hydrocarbons may include ethane, ethylene, propane, propylene, butane, and so forth. The C₂₊ hydrocarbons can include C₅₊ hydrocarbons. In implementations, the composition of the C₂₊ hydrocarbons may depend on the catalyst selection for the NTP catalysis.

Embodiments of the present techniques include treating a sour natural gas stream utilizing an NTP reactor (e.g. DBD, corona discharge, pulsed corona discharge, arc discharge, etc.) to (1) dissociate and activate H₂S, CO₂, and CH₄ gas molecules in the natural gas into H₂, CO, S, C₂₊ hydrocarbons, and other activated/excited gas molecules, and (2) activate the catalyst(s) to facilitate these reactions as catalytic reactions at relatively low temperatures (e.g., <300° C., <250° C., or <200° C., but generally greater than 150° C.). The C₂₊ hydrocarbons are hydrocarbons having two or more carbon atoms.

The mechanism for the plasma activating the catalyst can be considered. In some implementations, in the absence of plasma, the catalyst may have little or no activity under reaction conditions. However, in those examples, the presence of plasma can show an effect on the catalyst, such as that seen in changes in conversion and selectivity. While not wishing to be bound by theory, the catalyst may be activated due to the presence of radicals, ions, and other excited and reactive species associated with the plasma near or on the catalyst surface. Moreover, plasma may cause structural, physical, and/or chemical changes on the active sites on the catalyst (e.g., via particle-catalyst inelastic collisions) and thus promote the active sites to be more active.

The catalyst(s) may be utilized to (1) enhance or advance the conversion of H₂S, CO₂, and/or CH₄, (2) enhance or supplement the properties of the plasma, and (3) control products selectivity. First, the catalyst (e.g., via active sites) may provide for the catalytic-promoted conversions that are independent of or supplement the plasma. Second, with respect to instances where the catalyst may enhance plasma properties, an example is that catalyst particles with high electric constant could enhance electric field strength especially at contact points. Also, catalyst packing could modify the nature of the discharge (e.g. from microdischarge or streamer mode to a more spatially confined and surface one). Additionally, the chemical properties of the catalyst could alter the plasma; for example, higher silicon to aluminum (Si/Al) ratios on a given catalyst (e.g., HY zeolite) could lead to a larger drop of the electrical resistivity, and subsequently lower surface streamer propagation.

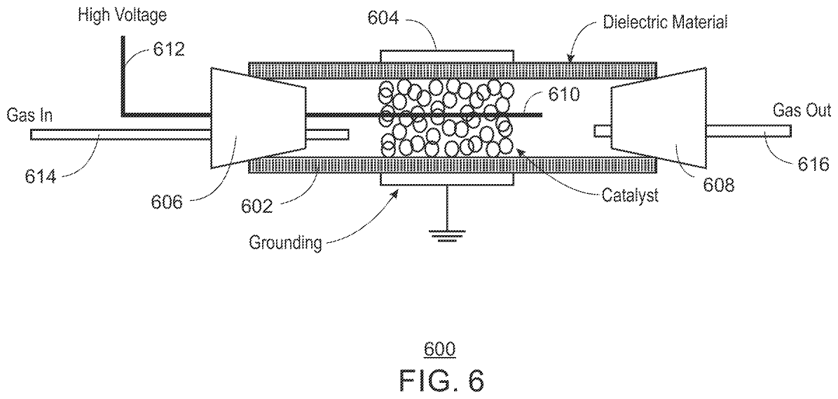

The solid catalyst(s) can be placed in (or partially in) the NTP reactor (such as in a plasma discharge zone of the NTP reactor and/or end portion of the NTP reactor) and/or downstream of the NTP reactor (e.g., in an outlet conduit) at or near the outlet of the NTP reactor. The portion of the NTP reactor in which the NTP is generated and exists may be labeled as the discharge zone. Again, in embodiments, the catalyst may be placed in this discharge zone (see, e.g., FIG. 6).

In embodiments, the NTP implementation can decompose (dissociate) H₂S (and CO₂) to reduce the cost of handling sour gas. Conventional techniques (e.g., amine-based absorption process, Claus sulfur recovery, etc.) are typically an energy-intense process, and also generally do not produce syngas or C₂₊ hydrocarbons as with implementations of the present techniques.

Acid gases (H₂S and CO₂) are common contaminants in natural gas reserves, and their concentration varies from trace amounts to more than 30 vol %. Some discovered natural gas reserves are not developed due to high costs of separating and handing high H₂S and CO₂ concentrations in the natural gas. Typically, gas sweetening units, such as unit operations employing liquid amine absorption, are employed to selectively capture and remove H₂S and CO₂ from the natural gas. However, the process generally become economically not feasible at high acid gas content. In many cases, this obstructs development of highly sour natural gas reserves. Therefore, developing new processes to monetize highly sour natural gas reserves is desirable.

The present disclosure relates to a technique to fully or partially convert H₂S and CO₂ in natural gas streams into other gases (e.g., H₂, sulfur, and CO). Depending on the sour natural gas composition, the disclosed process and system can be utilized to achieve complete (or substantially complete) conversion of H₂S in the natural gas. Hence, the product stream of treated natural gas can be utilized, for example, directly for power generation. The disclosed process may be employed to reduce the acid gas content in the natural gas prior to gas sweetening units

In the present disclosure, a NTP is combined with a catalyst(s) and thus may be labeled as NTP catalysis. The NTP catalysis at low temperatures (e.g., <250° C.) may simultaneously dissociate H₂S into H₂ and S (e.g., refer to reaction R1 below), dissociate CO₂ to CO (e.g., refer to reaction R2 below), convert CO₂ to CO (e.g., refer to reaction R3 below), and partially convert CH₄ into H₂ and C₂₊ hydrocarbons (e.g., refer to reaction R4 below):

H₂S→H₂+S (R1)

2CO₂→2CO+O₂ (R2)

CO₂+H₂→CO+H₂O (R3)

xCH₄→CₓH_{y}+[(4x−y)/2]H₂ (R4)

The formation of relatively small amounts of sulfur-containing byproducts, e.g., carbonyl sulfide (COS), carbon disulfide (CS₂), or sulfur dioxide (SO₂), is possible with the NTP catalysis. However, the catalyst(s) can be selected or designed (configured) to eliminate or reduce production of these byproducts.

A wide range of operating pressures, e.g., from less than 1 bar to more than 10 bar, can be implemented for the NTP catalysis, depending on the type of NTP. The unit “bar” as used herein refers to bar absolute (bara).

Nonthermal plasma (NTP) is a non-equilibrium process, and contains (at low temperatures) radicals and excited states of atoms and molecules that generally only can exist at thermal equilibrium at much higher temperatures (>1000° C.) compared to the low temperature (e.g., <250° C.) of the NTP. Therefore, the chemical processes occurring in the NTP are generally not possible in a system at less than 250° C. that is at thermal equilibrium. In NTP, highly energetic electrons interact with gas molecules as electron impact reactions. Such produces radicals, ions, and excited molecules that rotationally, vibrationally, and/or electronically excited molecules that facilitate chemical reactions at mild conditions. The excited molecules are rotationally, vibrationally, and/or electronically excited molecules.

There are different techniques to produced NTP, one of which is DBD. DBD is generated when the voltage between two electrodes (at least one of which is covered or blocked by a layer of dielectric material) is higher than the breakdown voltage of the gas passing in between the two electrodes. The voltage difference to generate NTP may depend on the gas composition, pressure, and the distance between the two electrodes. A catalyst(s) can be placed in between the two electrodes to increase the gas conversion and/or control the product selectivity by providing an alternative reaction pathway with a lower energy barrier.

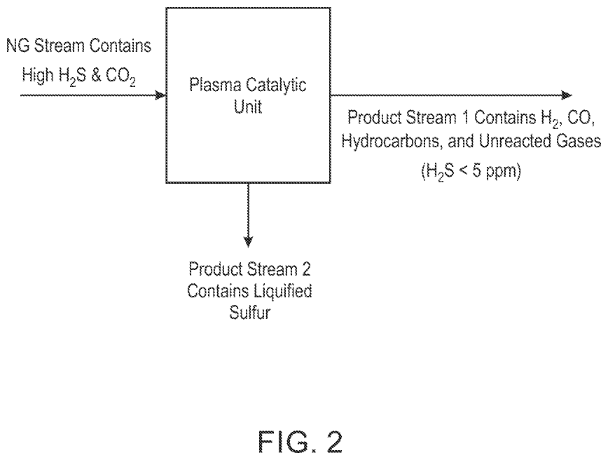

In implementations, the disclosed NTP catalytic process may directly treat H₂S and CO₂ simultaneously in natural gas streams and produce valuable products, such as H₂, CO, hydrocarbons, and elemental sulfur. In certain practices, the process completely (or substantially completely) converts H₂S into H₂ and S, and partially converts CO₂ and CH₄ into CO and C₂₊, respectively. See, for example, FIG. 2. Hence, the product stream of natural gas can be used, for example, in combustion for power generation with or without intervening H₂ and C₂₊ hydrocarbon recovery units

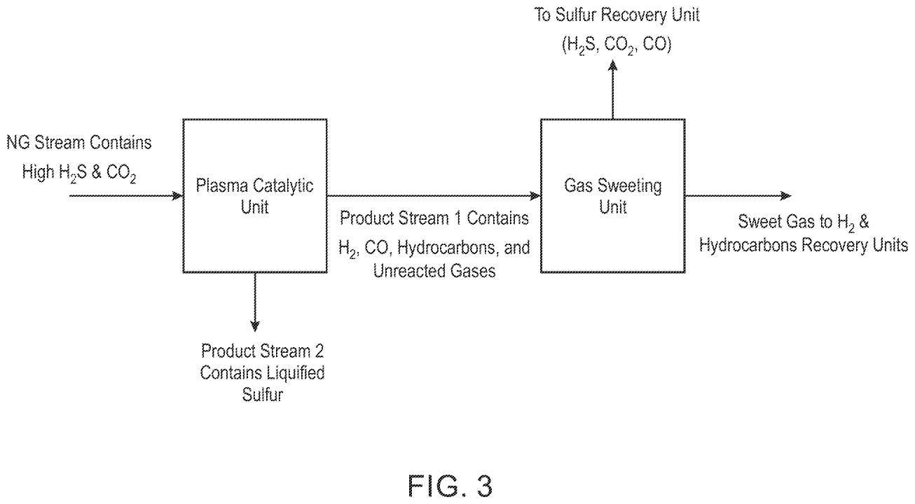

The disclosed process can be utilized as a pre-treatment process to reduce the acid gas content (e.g., convert some but not all of the H₂S) prior to typical gas sweetening units (e.g. amine units). See, for example, FIG. 3. Such a pretreatment process may put less load on (or facilitate debottlenecking of) the gas sweetening units.

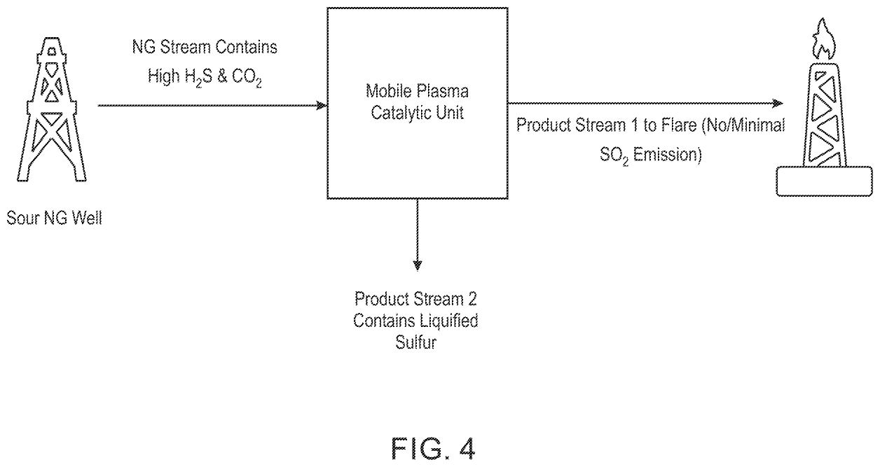

Another application is the disclosed process can be utilized for H₂S abatement during sour gas well testing to avoid relatively large SO₂ emissions at the flare. See, for example, FIG. 4.

A wide range of operating pressure may be implemented in the NTP depending, for example, on the technique or type of NTP. For instance, atmospheric pressure or near atmospheric pressure (e.g., in range of 0 bar to 1 bar) may be implemented for DBD, corona discharge, pulsed corona discharge, and gliding arc discharge. However, the operating pressure may be greater than atmospheric for these NTP techniques, such as for example, due to the system hydraulics of the flow of natural gas through the NTP unit. Moreover, higher operating pressure (e.g., at least 10 bar) may be applied related to the NTP implementation of arc discharge.

The operating temperature of the NTP can be, for example, in the range of 20° C. to 900° C. The operating temperature may be in the range of 150° C. to 200° C., 150° C. to 250° C., or 150° C. to 300° C. to reduce or limit sulfur deposition on the catalyst. In implementations, an operating temperature below 150° C. could lead to (cause) significant sulfur deposition. Operating at higher temperatures (e.g., greater than 300° C.) could facilitate formation of unwanted sulfur compounds (e.g., SO₂, COS, etc.)

The solid catalyst(s) may be placed fully or partially in the NTP reactor discharge zone (as in-plasma catalysis) or downstream of the NTP reactor discharge zone (as post-plasma catalysis). A single catalyst, bifunctional catalyst, and/or physical mixture of different catalysts may be utilized to simultaneously catalyze different catalytic reactions (e.g., H₂S splitting, CO₂ dissociation, and CH₄ conversion), control products selectivity, or enhance plasma properties, or any combinations thereof. The control of products selectivity can include eliminating or reducing unwanted byproducts, such as COS, CS₂, SO₂, etc. The catalyst can metal-based catalysts (e.g., metal includes iron), metal oxide-based catalyst (e.g., iron oxide), metal sulfide-based catalyst (e.g., molybdenum sulfide), or zeolite-based catalyst (microporous aluminosilicate) (e.g., H-ZSM-5), or any combinations thereof. These catalysts can be supported or unsupported.

As an example, supported transition metal sulfide is generally a good catalyst for reaction R1 (H₂S dissociation). The metal sulfide may be supported on alumina [aluminum oxide (Al₂O₃)]. Specific examples are molybdenum sulfide (MoS₂) supported on alumina, cadmium sulfide (CdS) supported on alumina, and zinc sulfide (ZnS) supported on alumina. Further, the produced H₂ (from H₂S dissociation) can react (as in R3) with CO₂ over iron oxide (e.g. Fe₂O₃) or iron-based alloy. The iron-based alloy may be, for example, an alloy (Fe—Ti) of iron and titanium, or an alloy (Fe—Ce—Ag) of iron, cesium, and silver. Photocatalysts, such as graphitic carbon nitride (g-C₃N₄) and titanium dioxide (TiO₂) may facilitate both dissociation reactions (R1, R2) of H₂S and CO₂. As for converting CH₄ to C₂₊ hydrocarbons, as in reaction R4, the reaction can occur in the gas/plasma phase without catalyst (or without catalyst directed to R4). Yet, a specific example of a catalyst to facilitate R4 is catalyst with iron (Fe) sites embedded in a silica [silicon dioxide (SiO₂)] matrix. A bifunctional catalyst to facilitate reactions R1, R2, R3, and R4 can be a physical mixture of MoS₂ (supported on ZrO₂) and Zeolite Socony Mobil-5 (ZSM-5) in the H form (H-ZSM-5). ZSM-5 is an aluminosilicate zeolite belonging to the pentasil family of zeolites. Its chemical formula is NaₙAlₙSi₉₆₋ₙO₁₉₂·16H₂O (0<n<27). Inclusion of catalyst in the plasma reactor can be optional to enhance the conversion rate and/or change the product selectivity. The reactions R1, R2, R3, and R4 can occur in the natural-gas plasma without the presence of catalyst. For implementations with catalyst included, the NTP may be referred to as NTP catalysis. The reactions R1 R2, R3, and R4 can occur simultaneously in the plasma catalytic system, which means some could be in the gas/plasma phase and some on the catalyst, and with considerations of the complicity of plasma-catalyst interaction.

Plasma-induced conversion/reaction (with or without catalysis) may generally not be a selective process with respect to what compounds in composition may be affected. In implementations, including for the NTP reaction without catalysis, H₂S and CO₂ generally cannot be selectively converted without some CH₄ conversion. A portion of the plasma energy will typically be directed to CH₄ conversion. CH₄ conversion to hydrocarbons typically cannot be completely eliminated, but the rate can be reduced depending on the reaction conditions and the choice of catalyst.

Embodiments of the NTP treat or convert the raw natural gas having impurities (e.g., H₂S, CO₂, etc.) into cleaner components (e.g., H₂) and/or more valuable components (e.g., syngas and C₂₊ hydrocarbons) and sweeten the raw natural gas at the same time. Because the plasma-induced conversion/reaction is generally not a selective process, some of the CH₄ will typically be involved in plasma conversion. The NTP process may focus on converting most or all of H₂S to element sulfur at relatively low cost. For amount of CH₄ conversion, such may depend on the amount of energy remaining after H₂S conversion. Because the conversion of CH₄ can be a side reaction in the H₂S converting process, the amount of input energy can be controlled to control H₂S conversion into elemental sulfur and CH₄ conversion into heavier hydrocarbons. The amount of input energy can depend on the economics of the NTP process. Several factors can influence the degree of CH₄ conversion. Therefore, these factors can be utilized to control the conversion. Such factors include, for example, plasma power, residence time, type of catalyst, reactor design, type of plasma, etc.

While plasma (NTP) may not generally be a selective process, the process can be configured (e.g., via catalyst selection, amount of energy input, reaction conditions, etc.) to focus on increased H₂S removal and reduced CH₄ conversion if desired. However, with some CH₄ converted to C₂₊ hydrocarbons, the C₂₊ hydrocarbons can have more value and uses than CH₄. The presence of the formed C₂₊ hydrocarbons in the natural gas increases the British thermal unit (BTU) value of the natural gas and hence more power may can be generated in the combustion of the natural gas. Liquid hydrocarbons (e.g., C₅₊) can be relatively easily separated and utilized to fuel the NTP unit in certain implementations. Downstream equipment can separate the C₂₊ hydrocarbons from the natural gas. Such downstream equipment may be disposed, for example, in a natural gas processing plant. The natural gas having the C₂₊ hydrocarbons can be burned in a flare in certain implementations.

The hydrocarbons selectivity (products distribution) may be a factor. For example, if generally only light hydrocarbons (e.g. C₂ and C₃) are present, then separation of the hydrocarbons from the natural gas may not be implemented for power generation with the natural gas. In other words, the light hydrocarbons can be readily fed along with the CH₄ to a furnace. On the other hand, if heavier hydrocarbons (e.g. C₅₊) are present, then separation in or downstream of the NTP unit may be implemented to recover the hydrocarbons.

The disclosed NTP technique can be a single or multi-stage with elemental sulfur condensation and removal. The NTP process (apparatus, system) can handle the presence of other gases in the feed, such as water vapor, nitrogen (N₂), hydrocarbons, and other contaminants that are typically present in natural gas streams.

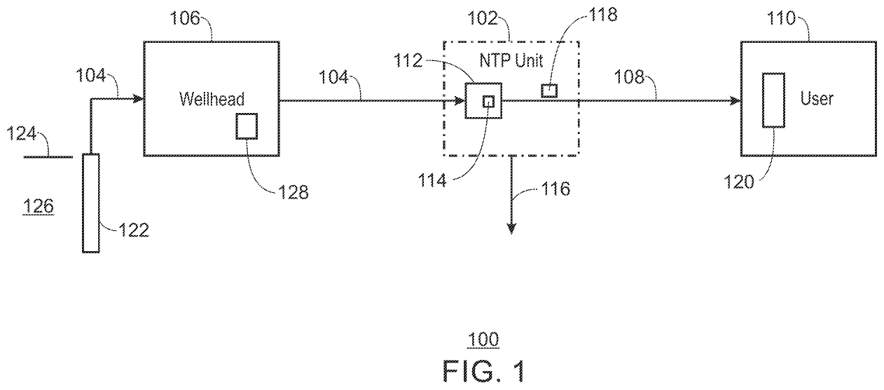

FIG. 1 is a system 100 for producing natural gas. A NTP unit 102 may receive natural gas 104 via an inlet conduit (supply conduit) from a wellhead 106 (or multiple wellheads 106). The plasma (NTP) in the NTP unit 102 may be the natural gas in its plasma state (NTP state) flowing in the discharge zone of the NTP unit 102. The NTP unit 102 may discharge treated natural gas 108 via an outlet conduit (discharge conduit) to a user 110 of the treated natural gas 108.

In implementations, the natural gas 104 may be characterized as the typical feed stream (e.g., a main feed stream) from a producing well or multiple producing wells to a natural gas processing plant. However, the provision of the natural gas 104 to a natural gas processing plant may be problematic for the natural gas 104 having high acid-gas content and without the treatment by the NTP unit 102 or other system.

The NTP unit 102 may be in fluid communication with the wellhead 106 for receipt of the natural gas 104 from the wellhead 106. The NTP unit 102 may be in fluid communication with the user 110 for supply of the treated natural gas 108 to the user 110. In implementations, the system 100 may be a continuous system (as opposed to a batch system). The wellhead 106, the NTP unit 102, and the user 110 may act in concert as a continuous operation (as opposed to a batch or intermittent operation) for the NTP catalysis treatment of the natural gas 104 and the supply of the NTP-catalysis treated natural gas 108 to (and receipt at) the user 110.

In implementations, the wellhead 106 pressure may provide motive force for flow of the natural gas 104 to and through the NTP unit 102, and for flow of the treated natural gas 108 from the NTP unit 102 to the user 110. In some implementations, a mechanical compressor (not shown) can be disposed along the inlet conduit to provide motive force (e.g., as a supplement to the wellhead 106 pressure) for flow of the natural gas 104 from the wellhead 106 to the NTP unit 102. Similarly, a mechanical compressor can be disposed along the outlet conduit to provide motive force for flow of the treated natural gas 108 to the user 110.

In certain implementations, the natural gas 104 received from the wellhead 106 at the NTP unit 102 may be sour natural gas, e.g., having at least 20 vol % of acid gas, or at least 30 vol % of acid gas. Acid gas is primarily H₂S and CO₂, and can include similar acidic gases. In some implementations, the natural gas 104 may have at least 10 vol % of H₂S, and thus can be labeled as sour natural gas with the presence of those amounts of H₂S. In operation, the NTP unit 102 may sweeten the natural gas 104 to discharge the treated natural gas 108 having less than 20 vol % of acid gas and less than 10 vol % of H₂S in particular. The NTP unit 102 may convert H₂S and CO₂ in the natural gas 104 to give the treated natural gas 108 having less acid gas. Depending on the application, the NTP unit 102 may convert substantially all of the H₂S or only a portion of the H₂S in the natural gas 104.

The natural gas 104 may have at least 15 vol % acid gas, at least 20 vol % acid gas, at least 25 vol % acid gas, or at least 30 vol % acid gas. The natural gas 104 can have less than 15 vol % acid gas. The natural gas 104 may have acid gas, for example, in the ranges of 1 vol % to 20 vol %, 5 vol % to 25 vol %, 10 vol % to 30 vol %, 15 vol % to 40 vol %, or 20 vol % to 50 vol %. The natural gas 104 may have at least 8 vol % H₂S, at least 10 vol % H₂S, at least 12 vol % H₂S, or at least 15 vol % H₂S. The natural gas 104 can have less than 8 vol % H₂S. In some examples, the natural gas has no H₂S. The natural gas 104 can have H₂S, for example, in the ranges of 0.1 vol % to 30 vol %, 1 vol % to 25 vol %, 3 vol % to 20 vol %, or 6 vol % to 18 vol %. The natural gas 104 may have at least 8 vol % CO₂, at least 10 vol % CO₂, at least 12 vol % CO₂, or at least 15 vol % CO₂. The natural gas 104 can have less than 8 vol % CO₂ including little or no CO₂. The natural gas 104 can have CO₂, for example, in the ranges of 0.1 vol % to 30 vol %, 1 vol % to 25 vol %, or 8 vol % to 20 vol %.

The treated natural gas 108 may have less than 20 vol % acid gas, less than 10 vol % acid gas, less than 5 vol % acid gas, less than 2 vol % acid gas, or less than 0.5 vol % acid gas. The treated natural gas 108 may have less than 10 vol % H₂S, less than 5 vol % H₂S, less than 1 vol % H₂S, less than 0.3 vol % H₂S, less than 0.1 vol % H₂S, or less than 100 ppmv H₂S. The treated natural gas 108 may have less than 15 vol % CO₂, less than 10 vol % CO₂, less than 5 vol % CO₂, less than 1 vol % CO₂, or less than 0.3 vol % CO₂.

The NTP unit 102 may be labeled as a NTP catalytic unit, a NTP system, a NTP catalytic system, and so forth. The NTP unit 102 includes a NTP reactor 112 to excite molecules in the natural gas 104 to place the natural gas 104 in a plasma phase (NTP phase) to cause dissociation reactions of H₂S and CO₂. In the plasma state (plasma phase), some of the CH₄ in the natural gas 104 can be converted to C₂₊ hydrocarbons. The NTP unit 102 may include multiple NTP reactors 112 is parallel and/or series. The NTP technique in the NTP reactor 112 may be, for example, DBD, corona discharge, pulsed corona discharge, gliding arc discharge, arc discharge, and so forth. NTP is generated by an electrical discharge. Thus, the word “discharge” may be given in the name of NTP types. The NTP type corona can be referred to as corona discharge or corona plasma.

DBD utilizes two electrodes separated by an intervening dielectric material. Corona discharge employs two electrodes that are asymmetric with respect to each other. Pulsed corona discharge may be similar to corona discharge (generally continuous) but with the high voltage being pulsed. Pulsed corona discharge may be useful to increasing corona power generally without transition to sparks. Gliding arc discharge utilizes two diverging electrodes. Arc discharge is generated between two electrodes with similar of different geometry. The geometry may be, for example tip-to-plan configuration. Arc discharge may be, for example, a low-current arc discharge or high-current thermal arc discharge.

The NTP unit 102 includes catalyst 114 to facilitate (and that may direct) these reactions (e.g. R1, R2, R3, and R4) caused by the NTP. The catalyst 114 may be in the NTP reactor 112, as depicted (e.g., for in-plasma catalysis). If the catalyst 114 is in the NTP reactor 112, the catalyst may be in a discharge portion of the NTP reactor 112 in some implementations. The catalyst 114 can be situated in the discharge conduit from the NTP reactor 112 (e.g., for post-plasma catalysis) instead of (or in addition to) in the NTP reactor 112. The catalyst 114 may be partially in the NTP reactor 112 and partially in the discharge conduit external to NTP reactor 112. In some implementations, the diameter of a portion of the discharge conduit can be enlarged to accommodate the catalyst 114, or a vessel may be disposed at or near (e.g., within 5 meters of) the NTP reactor 112 outlet along the discharge conduit to hold the catalyst 114, and the like.

The dissociation reaction of H₂S can give elemental sulfur (S) that can be liquid or gas (and condensed if gas), and removed from the natural gas 104 and from the NTP unit 102 as liquid elemental sulfur 116. At the lower operating temperatures (e.g., less than 250° C.) of the NTP reactor 112, the elemental sulfur may condense or be formed as liquid elemental sulfur in the reactor 112. The reactor 112 may have a second outlet to discharge the liquid elemental sulfur 116.

Again, in the NTP reactor 112, the elemental sulfur may be generated as sulfur gas or liquid sulfur in the H₂S decomposition depending, for instance, on the reactor temperature and the concentration of the H₂S and sulfur in the natural gas. Thus, the elemental sulfur formed can be in the gas phase or in the liquid phase. The reaction conditions must be adjusted in the NTP reactor 112 to avoid sulfur deposition on the catalyst 114. Sulfur deposition on the catalyst 114 can lead to deactivation of the catalyst 114.

If some or all the elemental sulfur is formed as sulfur gas, the sulfur gas may be condensed into sulfur liquid because of (1) the low temperature (e.g., <250° C.) of the NTP reactor 112, and/or (2) with implementation of a heat exchanger condenser in the NTP unit 102 downstream of the NTP reactor 112 to condense the elemental sulfur gas. In implementations, liquid elemental sulfur may be separated from the natural gas in a vessel in the NTP unit 102 downstream of the NTP reactor 112.

In general, the NTP unit 102 may have a separator 118 disposed along the discharge conduit from the natural-gas outlet of the NTP reactor 112. The separator 118 may collect and remove the liquid elemental sulfur 116 from the treated natural gas 108 for discharge of the liquid elemental sulfur 116 from the NTP unit 102 as depicted. The separator 118 can be a vessel that is a liquid-gas separator vessel (e.g., a knockout pot or drum) to collect the liquid elemental sulfur 116 from the natural gas and discharge the liquid elemental sulfur 116 from the bottom portion of the vessel. The treated natural gas 108 may discharge from a side or overhead (top portion) from the vessel.

In some implementations, the separator 118 is a heat exchanger (e.g., shell-and-tube heat exchanger) that condenses any elemental sulfur gas in the treated natural gas, discharges the liquid elemental sulfur 116 for collection, and forwards on the treated natural gas 108 via the discharge conduit to the user 110. In certain implementations, the cooling medium for the heat exchanger may be cooling water, such as cooling tower water, utility water, plant water, or steam condensate. For this condenser heat exchanger as a shell-and-tube heat exchanger, the condensed elemental sulfur (liquid elemental sulfur 116) may discharge from shell side or the tube side of the exchanger and thus from the NTP unit 102.

The inlet conduit to the NTP unit 102 and of the outlet conduit on the discharge side of the NTP unit 102 may both be steel. In one implementation, the inlet conduit and the outlet conduit are carbon steel, and with the conduit between the NTP reactor 112 and the separator 118 (e.g., sulfur condenser heat exchanger) being stainless steel.

The user 110 may have one or more unit operations 120 to utilize, process, or dispose of the treated natural gas 108. The user 110 may be, for example, a boiler, a flare system, a natural gas processing plant, or a hydrocarbon-processing unit, or other users 110. For the user 110 of the treated natural gas 108 as a boiler, the boiler burner or furnace (as the unit operation 120) combusts the treated natural gas 108 for the boiler to generate steam. The generated steam may be utilized to drive a turbine for power (electricity) generation. The steam may be utilized as a heating medium in the user 110 facility.

The user 110 may be a flare system having a flare header and a flare. The flare may be characterized as a unit operation 120. The treated natural gas 108 may enter the flare header (conduit) in route to the flare. The treated natural gas 108 may flow from the flare header through the flare stack of the flare to the flare tip of the flare. The flare tip may ignite and combust the treated natural gas 108 for disposal. In such implementations, the NTP unit 102 may be disposed at a well site having the wellhead 106, and the flare disposed at the well site or adjacent well site.

The user 110 may be a natural gas processing plant that processes the treated natural gas 108 for distribution to downstream users. One of ordinary skill in the art is familiar with natural gas processing plants. A natural gas processing plant may receive and purify the treated natural gas 108, and discharge pipeline quality dry natural gas for end users. The natural gas used by consumers is composed almost entirely of methane.

In a natural gas processing plant, an example of a unit operation 120 that may process the treated natural gas 108 is a sweetening unit (e.g., amine treatment) to treat natural gas 108 (e.g., with a liquid amine solution) in a vessel (e.g., a tower) to remove H₂S from the treated natural gas 108. The sweetening unit may receive sour natural gas and discharge sweet natural gas. In implementations, the liquid amine absorbs the H₂S from the treated natural gas 108. Yet, if the NTP unit 102 removes all or substantially all of the H₂S and thus the treated natural gas 108 is generally free of H₂S, the treated natural gas 104 may bypass the sweetening unit in implementations. If the NTP unit 102 removes a portion of the H₂S, the treated natural gas 108 (with remaining H₂S) may be routed through the sweetening unit but beneficially places a lighter load on the sweetening unit compared to if no treatment with the NTP unit 102.

Another example of a unit operation 120 in a natural gas processing plant as the user 110 can be a glycol dehydration unit to remove water from the treated natural gas 108. A glycol dehydration unit has a vessel that is an absorber column (e.g., having packing) in which glycol, e.g., triethylene glycol (TEG), as a liquid desiccant absorbs water from the natural gas.

In certain implementations for the user 110 as a natural gas processing plant, the NTP unit 102 may be disposed adjacent or near (e.g., within 200 meter of) the natural gas processing plant. In some examples, the NTP unit 102 may be a component of the natural gas processing plant. In other implementations, the NTP unit 102 may be disposed at or near the wellhead 106, or approximately equidistant between the wellhead 106 and the natural gas processing plant.

The natural gas 104 produced through the wellhead 106 and through the inlet conduit to the NTP unit 104 may include primarily CH₄, for example, at 55-85 vol %. In some examples, the NTP unit 104 may treat a stream 104 having less than 55 vol % CH₄ (e.g., CH₄ in the range of 10 vol % to 50 vol %) from the wellhead 106 or other source. The natural gas 104 may include higher alkanes (e.g., ethane, propane, butane) and other components (e.g., acid gas, water vapor, nitrogen, etc.). In some implementations the flow rate (e.g., volumetric rate, mass rate, or molar rate) of the natural gas 104 fed to the NTP unit 102 may be controlled via at least one flow control valve disposed along the inlet (supply) conduit or by a mechanical compressor, or a combination thereof. In implementations, the supply pressure of the natural gas 104 may provide for or facilitate the operating pressure in the NTP unit 102 including in the NTP reactor 112. As mentioned, the natural gas 104 may have at least 20 vol % acid gas and/or at least 10 vol % H₂S. In some examples, the natural gas 104 may have less than 20 vol % acid gas and/or less 10 vol % H₂S. In certain instances, the natural gas 104 may have significant CO₂ (e.g., at least 5 vol % CO₂) but little or no H₂S (e.g., less than 100 ppmv H₂S). In other instances, the natural gas 104 may have significant H₂S (e.g., at least 5 vol % H₂S) but little or no CO₂ (e.g., less than 0.5 vol % CO₂).

The NTP unit 102 is applicable to treat natural gas 104 having generally any concentration of acid gas from little or no acid gas (e.g., less than 1 vol % acid gas) to more than 20 vol % acid gas, more than 30 vol % acid gas, etc. The natural gas 104 may have acid gas, for example, in the ranges of at the lower end of 0.5 vol %, 1 vol %, 2 vol %, or 5 vol % up to at the higher end of 20 vol %, 25 vol %, 30 vol %, 35 vol %, 40 vol %, 45 vol %, or 50 vol %. The NTP unit 102 is applicable to treat natural gas 104 having generally any concentration of H₂S from no H₂S to more than 10 vol % H₂S, more than 20 vol % H₂S, etc. The natural gas 104 may have H₂S, for example, in the ranges of at the lower end of none, 100 ppmv, 0.1 vol %, 1 vol %, 2 vol %, or 5 vol % up to the higher end of 8 vol %, 10 vol %, 15 vol %, 20 vol %, 25 vol %, or 30 vol %. The NTP unit 102 is applicable to treat natural gas 104 having generally any concentration of CO₂ from no CO₂ to more than 10 vol % CO₂, more than 20 vol % CO₂, etc. The natural gas 104 may have CO₂, for example, in the ranges of at the lower end of none, 0.1 vol %, 1 vol %, 2 vol %, 5 vol %, or 10 vol % up to the higher end of 12 vol %, 15 vol %, 20 vol %, 25 vol %, 30 vol %, 35 vol %, or 40 vol %.

The system 100 may include a gas well (or oil and gas well) having the wellhead 106 coupled to a wellbore 122 formed through the Earth surface 124 into a subterranean formation 126. The natural gas 104 may be produced from the subterranean formation 126 through the wellbore 122 to the wellhead 106. For the wellbore 122 as a cemented cased wellbore, the natural gas 104 may flow into the wellbore 122 from the subterranean formation 126 through perforations in the cement and the casing.

The natural gas 104 as produced from the formation 126 and discharged from the wellbore 122 to the wellhead 106 may have liquid (e.g., crude oil, condensate, water, etc.). In those instances, liquid can be removed from the natural gas 104 at or near the wellhead 106 in certain implementations. A separator 128 at the wellhead 106 may be employed to separate liquid from the natural gas 104. In some examples, the separator 128 may include a vessel or piping for the straightforward separation of liquid from the natural gas. Water vapor may remain in the natural gas 104 and be separated, for instance, from the treated natural gas 108 via glycol dehydration in a user 110, such as a downstream natural gas processing plant. In certain examples, the natural gas 104 and the produced liquid may separate due to decreased pressure at the wellhead 106. In these cases, the separator 128 may be a vessel, such as a closed tank, where gravity serves to separate the liquid and natural gas 104. In examples, the separator 108 may be a low-temperature separator (LTX) that may include a heat exchanger, a choke to expand the gas, and liquid knockout vessel to separate liquid from the natural gas 104.

The natural gas 104 may flow from the wellhead 106 through a production manifold associated with one or more wellheads to the inlet conduit to the NTP unit 102. The natural gas 104 received at the NTP unit 102 may be from a well pool. In implementations, the natural gas 104 received at the NTP unit 102 can be characterized as raw natural gas as produced from the subterranean formation 126 and that has been subjected to little or no processing.

Lastly, while the discussion herein has focused on natural gas 104, the stream 104 may instead be a methane stream having H₂S or acid gas. Sources of methane can include, for example, biogas or landfill gas. In general, the stream 104 as a methane stream can be a process stream or waste stream, or a stream from methane storage. As for storage supply, instead of a producing well having a wellhead 106 as the source of the stream 104, the source may be methane stored in refrigerated containers or methane stored in ground through gas reinjection, such as in a mined salt cavern or other subterranean formation.

FIG. 2 is a NTP catalytic unit, such as the NTP catalytic unit 102 of FIG. 1. The NTP catalytic unit receives natural gas (NG) that may have at least 10 vol % H₂S and at least 10 vol % CO₂. The NTP catalytic unit completely converts H₂S into H₂ and S, and partially converts CO₂ and CH₄ into CO and C₂₊ hydrocarbons, respectively. Therefore, with or without removal of the H₂ and the C₂₊ hydrocarbons, the discharged product stream 1 can be fed, for example, to a boiler furnace for combustion for power generation. FIG. 2 can be characterized as a block flow diagram for the plasma (NTP) catalytic processing of sour natural gas.

As depicted, the NTP catalytic unit discharges product stream 1 that is treated natural gas. The treated natural gas includes unreacted gases of the entering natural gas and has H₂ (via R1 and R3), CO (via R2 and R3), and C₂₊ hydrocarbons (via R4) formed from the natural gas in the NTP catalytic unit. In the illustrated embodiment, the product stream 1 has less than 5 ppmv of H₂S. Beneficially, with the low H₂S and the formed combustible H₂ and C₂₊ hydrocarbons, the product stream 1 may be utilized for power generation, as mentioned. Lastly, to give the product stream 1, the elemental sulfur formed in the NTP catalytic unit is discharged removed from the natural gas as product stream 2 that is liquid elemental sulfur.

FIG. 3 is a system having a NTP catalytic unit (e.g., 102 of FIG. 1) and a gas sweetening unit. In implementations, the gas sweetening unit is disposed in a natural gas processing plant. In certain implementations, the NTP catalytic unit can be disposed at an inlet battery limit of (or in) the natural gas processing plant. A benefit of the FIG. 3 embodiment may be that the NTP catalytic unit pretreats the natural gas in converting some of the H₂S and CO₂, and therefore lightens the load on the sweetening unit. For instance, in a particular example, the natural gas entering the NTP catalytic unit has a combined amount of at least 20 vol % (e.g., 20 vol % to 50 vol %) of acid gas, and the treated natural gas exiting the NTP catalytic unit has less than 15 vol % (e.g., 8 vol % to 15 vol %) of acid gas. While in this particular example, a significant amount of acid gas remains in the treated natural gas, the acid-gas load on the downstream sweeting unit is nevertheless lightened. Other examples with differing concentrations of acid gas are applicable.

In the illustrated embodiment, the NTP catalytic unit can be employed as a pre-treatment system to reduce the acid gas content of natural gas prior to processing the natural gas in the gas sweetening unit (e.g., a typical gas sweetening unit, such as an amine unit). This can accommodate debottlenecking of the gas sweetening unit. FIG. 3 can be characterized as a block flow diagram for a plasma catalytic process coupled with a gas sweetening unit for sour natural gas processing.

As shown in FIG. 3, a natural gas stream having primarily CH₄ and that has high concentrations of H₂S and CO₂ passes through the NTP catalytic unit before entering the gas sweetening unit. In the NTP catalytic unit, some of the H₂S (if present) is converted (dissociated) via the aforementioned reaction R1 into H₂ and elemental sulfur. In the NTP catalytic unit, some of the CO₂ (if present) is converted via the aforementioned reactions R2 and R3 into CO, O₂, and H₂O. In the NTP catalytic unit, some of the CH₄ may be converted via the aforementioned R4 reaction into C₂₊ hydrocarbons. The elemental sulfur can be removed from the natural gas and the NTP catalytic unit as liquid elemental sulfur (product stream 2). The remainder of the composition in the NTP catalytic unit discharges from the NTP catalytic unit as product stream 1 that is treated natural gas, which includes the product gases H₂, CO, and C₂₊ hydrocarbons and unreacted gases including unreacted acid gas. This treated natural gas (product stream 1) may be fed to the gas sweetening unit. In implementations to give the treated natural gas for the sweetening unit, the amount of acid gas in the natural gas that is converted via the NTP catalytic unit is less than 90%, less than 80%, less than 70%, less than 60%, or less than half of the acid gas in the natural gas (NG) entering the NTP catalytic unit. In implementations to give the treated natural gas for the sweetening unit, the amount of H₂S (if present) in the natural gas that is converted into elemental sulfur via the NTP catalytic unit is less than 90%, less than 80%, less than 70%, less than 60%, or less than half of the H₂S in the natural gas (NG) entering the NTP catalytic unit.

The gas sweetening unit can be an amine process system, as discussed, having an amine tower (vessel that is a column), in which a liquid amine solution absorbs H₂S from the treated natural gas. The gas sweetening unit may remove H₂S, CO₂, and CO from the treated natural gas and discharge these components, for example, to a sulfur recovery unit (SRU), such as a Claus process system. The SRU may convert the H₂S and any formed sulfur dioxide (SO₂) into elemental sulfur, such that emissions of H₂S and SO₂ are little or approaching none. The gas sweetening unit may discharge the treated natural gas as sweet gas (sweeten treated natural gas), to downstream processing, such as H₂ and hydrocarbon recovery units.

FIG. 4 is a system including a sour natural gas well, a mobile NTP catalytic unit, and a flare. The mobile NTP catalytic unit may be a mobile version of the NTP catalytic unit 102 of FIG. 1. The mobile NTP catalytic unit can be employed for H₂S abatement during well operations (e.g., drilling, well testing, workover operations, etc.) that discharge sour natural gas to the flare. In examples, the well testing may typically be employed for new gas wells to check the quality of the natural gas (e.g., compositions, pressure, expected flow rate, etc.). For the well testing (e.g., during an initial stage of well development), the produced natural gas is flared onsite as the purpose is not for mass production of natural gas, but instead to check the feasibility of developing this well. The produced natural gas sent to the onsite flare during testing or maintenance activities may be labeled as discharges or purges to the flare.

The removal of H₂S from the discharges to the flare can avoid significant SO₂ emissions from the flare. The NTP catalytic unit can remove H₂S from well natural-gas purges to the flare and thus less H₂S is combusted in the flare, therefore giving less emissions of SO₂ (a product of H₂S combustion). The mobile NTP catalytic unit may have a relatively small footprint and can be mobilized and demobilized, unlike typical amine units and SRU units, for well testing. Once in place, the nature of NTP may be a relatively quick start up of running the NTP in a matter of minutes, as compared to hours or days with a typical SRU. FIG. 4 may be characterized as a block flow diagram for the plasma (NTP) catalytic process (mobile unit) for well testing to avoid SO₂ emission. The NTP catalytic treating of the natural gas with the mobile NTP catalytic unit can be to decompose (dissociate) H₂S and CO₂ in the natural gas to reduce emissions of SO₂ and CO₂ in the flaring of the natural gas.

In some implementations, the aforementioned well operations that discharge to the flare and the associated utilization of the mobile NTP catalytic unit can be temporary, such as for days or months. For instance, the duration of such well operations may be less than 30 days or less than 6 months.

In examples, the mobile NTP unit may be mounted on a vehicle (e.g., truck or trailer), or be a skid unit moved on a vehicle and then offloaded from the vehicle to the ground at the well site. The mobile NTP unit may typically be disposed adjacent or near the wellhead (e.g., within 100 meters of the wellhead) and discharge to a flare at the well site. The mobile NTP unit may discharge to a flare header that routes flow of the natural gas to the flare. In implementation, the mobile NTP unit ties into electrical supply at the well site to receive power (high voltage). In some implementations, some of the power utilized by the mobile NTP unit may be generated from the treated natural gas instead of flaring that portion of the treated natural gas.

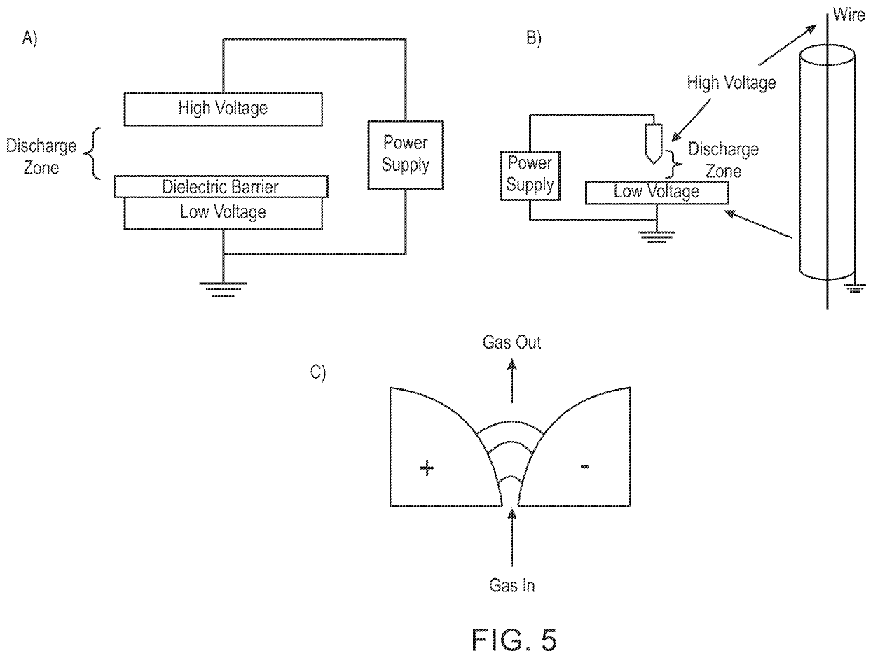

FIG. 5 gives representations of three common NTP types including A) DBD, B) corona discharge, and C) gliding arc discharge. The NTP type DBD includes a high voltage electrode and low voltage electrode (grounding) with a dielectric barrier there between. In general, DBD is the electrical discharge between two electrodes separated by an insulating dielectric barrier. The DBD unit may employ a power supply giving high voltage alternating current, ranging from lower radio frequency (RF) to microwave frequencies. The discharge zone for the gas plasma (NTP formed from gas) exists between the electrodes. The gas can be natural gas or a methane stream, as discussed. In operation, multitudes of random arcs, micro-discharges, or streamers form in the operation gap (discharge zone) between the two electrodes during discharges in the gas (e.g., at atmospheric pressure). In DBD, the random arcs may be more accurately labeled as micro-discharges or streamers instead of arcs because the dielectric material will generally prevent arcing. The contained plasma (NTP) may be sustained with the continuous energy source providing for ionization in overcoming recombination that could lead to extinction of the discharge plasma. The DBD unit can be made in different configurations including planar and cylindrical. A planar configuration may utilize parallel plates separated by a dielectric. A cylindrical configuration may utilize coaxial plates with a dielectric tube between them. For examples of a coaxial configuration, see FIGS. 6-9. DBDs are applicable for their decomposition of different gaseous compounds, such as ammonia (NH₃), H₂S, and CO₂.

The depicted B) corona gives two representations of corona discharge for NTP. The representation on the left shows a high voltage electrode bar (having a sharp point) and a low voltage electrode plate (with grounding). The discharge zone is there between. The corona unit includes a power supply. The representation on the right shows a low-voltage electrode that is a hollow cylinder (grounded) and a high voltage electrode that is a wire situated in the center hollow portion of the cylinder. The discharge zone is the annulus between wire electrode and the cylinder electrode. This corona unit includes a power supply (not shown). In both representations, the gas (e.g., natural gas) being treated flows through the discharge zone and is temporarily placed in a plasma state (NTP state) in the discharge zone.

A corona discharge is a process by which a current flows from an electrode into gas in the discharge zone, thereby ionizing the gas to generate plasma (NTP) of the gas. Corona discharges generate non-thermal, non-equilibrium product (plasma) and generally do not release adequate energy to heat the plasma. Corona discharge can take place at atmospheric pressure in contrast to low temperature (or cold) plasma implemented under a vacuum. Corona is a stream of charged particles, such as electrons and ions, accelerated by an electric field. Corona plasma (NTP) is generated when a space gap filled with gas is subjected to a sufficiently high voltage to set up a chain reaction of high-velocity particle collisions.

As indicated, corona generation systems typically take the form of two opposing electrically conductive electrodes separated by a gap containing the gas from which the plasma is generated. The two electrodes are connected to a high-voltage source (power supply). The electrodes may be powered with high, continuous or pulsed DC or AC voltages. The geometry of the two electrodes with respect to each other is asymmetric. For instance, for the depicted B) corona discharge, the representation on the left shows the high voltage electrode as pointed (e.g., a sharply pointed bar or needle) and the low voltage electrode as generally flat (e.g., a flat plate). In the representation on the right, the electrodes are also asymmetric. The high voltage electrode is a thin wire and the low voltage electrode is a relatively large diameter cylinder.

The representation of C) NTP gliding arc depicts two electrodes shaped as diverging with respect to each other. One electrode is a high voltage electrode. The other electrode is a low voltage electrode. The gas (e.g., natural gas) being treated flows between (along) the two diverging electrodes and is placed in a plasma state (NTP state) between the electrodes. The gliding arc discharge between the two diverging electrodes is depicted as three curves. The phases of the gliding-arc discharge process through the path between the electrodes may be initiation, elongation, and extinguish. The evolution cycle of gliding arc discharge starts from the gas breakdown at the narrow gap portion. A high-power supply provides the electrical field for the gas breakdown.

FIG. 6 is a representation of an approximate cross-section of an NTP reactor that is a DBD packed-bed reactor 600. The reactor 600 includes a cylindrical dielectric material 602 defining an inside volume of the reactor 600. The inside diameter of the dielectric material 602 is the diameter of the inside volume of the reactor 600. A cylindrical low voltage electrode 604 (grounded) radially surrounds an axial length portion of the dielectric material 602. The two open axial ends of the dielectric material 602 are sealed (covered, closed) with conduit fittings 606, 608. The inlet conduit fitting 606 closes the inlet end of the dielectric material 602 cylinder. The outlet conduit fitting 608 closes the outlet end of the dielectric material 602 cylinder. Catalyst is disposed in the reactor 600, such as in the inside volume of the reactor 600 defined by the dielectric material 602. The catalyst may be catalyst pellets but more generally may be catalyst particles that are spherical or irregular shape, or other shape. Moreover, the simplified representation of particle size of the catalyst relative to the reactor 102 size may be smaller than depicted. A high-voltage bar, wire, or rod electrode 610 is situated in the inside volume of the reactor 600, and can run through the catalyst in implementations. The dielectric material 602 situated between the two electrodes 604, 610 gives a DBD configuration. A high-voltage cable 612 (e.g., wire with protective cable coating) may supply the voltage from a power supply to the electrode 610. The rod electrode 610 may be characterized as the high-voltage electrode. The cable 612 or rod electrode 610, or both, can be routed, for example, through the inlet conduit fitting. The voltage may be, for example, in the range of 1 kilovolt (kV) to 50 kV. The numerical range for the high voltage supplied to the DBD unit may depend on the frequency utilized and on the geometry of the reactor, such as the gap between the high voltage and low voltage electrodes.

An inlet conduit 614 is routed through or coupled with the inlet conduit fitting 606. An outlet conduit 616 is routed through or coupled with the outlet conduit fitting 608. In operation, gas (e.g., natural gas flowing from a wellhead) may flow through the inlet conduit 614 into the reactor 600 where the gas is transitioned into a plasma state (NTP state). As the operation may be a continuous operation (and with the reactor being a continuous reactor), the gas flows through the reactor 600 and discharges through the outlet conduit 616 (discharge conduit) from the reactor 600. The gas may flow to a user, such as via the outlet conduit 616.

Again, the high voltage may be received and applied by supplying electricity through coated wire 612 onto the exposed wire rod 610 inside the DBD-packed bed reactor 600. The high voltage may be supplied to (and received at) the reactor 600 via the coated (insulated) wire 612 that is connected to the bare metallic rod 610 (inside the DBD reactor 600) that acts as a high voltage electrode. The metallic rod 610 inside the DBD reactor can be exposed to the natural gas and catalyst (as depicted) or covered by an additional dielectric material for a doubled DBD reactor.

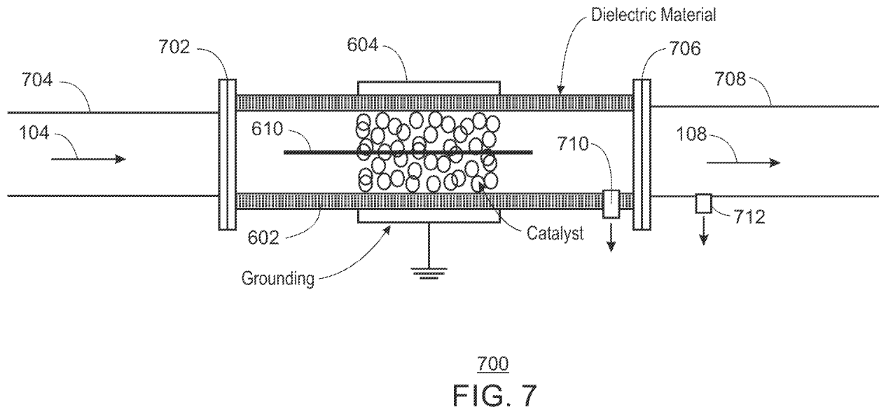

FIG. 7 is a representation of an approximate cross-section of a NTP DBD packed-bed reactor 700 that combines the plasma (NTP) process with a catalyst(s). FIG. 7 is a simplified schematic diagram of the DBD packed-bed reactor 700 having a packed bed of the catalyst and with a high voltage electrode 610 (metal rod) and a grounding electrode 604. The electrode rod 610 is inserted in the center portion of the reactor 700. An electrical cable (not shown) may supply electricity at high voltage (e.g., 1-50 kV) from a power supply to the electrode 610. The grounding electrode 604 (e.g. aluminum foil or mesh) may wrap around the dielectric material 602 on an outside portion of the reactor 700. The two electrodes 604, 610 with the intervening dielectric material 602 provides for an NTP DBD process. In operation, the natural gas 104 entering the reactor 700 may be a plasma (NTP) in the inside volume of the reactor 700 between the two electrodes 604, 610.

The reactor 700 includes the cylindrical dielectric material 602 forming an inside volume of the reactor 700. In the illustrated implementation, the inside diameter of the dielectric material 602 gives the diameter of the inside volume of the reactor 700. The dielectric material 602 may be, for example, ceramic, glass, or non-conductive composite material, and the like. The cylindrical low voltage electrode 604 (grounded) radially surrounds an axial length portion of the cylindrical dielectric material 602. The grounding electrode 604 can be the geometry of foil, mesh, coil, cylindrical plate, tube, etc., and the grounding electrode 604 can be aluminum, copper, alloy, steel, etc.

An alternative to the illustrated embodiment, the grounding (low voltage) electrode 604 can be a cylindrical steel conduit (tube) forming the inside volume of the reactor 700 (with no dielectric material 602 on the outside), and the dielectric material 602 covers the high voltage electrode 610 (metal rod). Thus, the discharge path (zone) for forming plasma (NTP) with the natural gas 104 would be the annulus between the dielectric material 602 and the low voltage electrode 604 (as a steel cylinder).

In the illustrated embodiment, the inlet axial end of the reactor 700 is coupled via a connection 702 to an inlet conduit 704 (pipe). The outlet axial end of the reactor 700 is coupled via a connection 706 to an outlet conduit 708 (pipe). The connections 702, 706 may be flanged, as depicted, or each can be a screwed connection (threaded), a welded connection, etc. In certain implementations, an outlet 710 may disposed on the reactor 700 for removal of liquid elemental sulfur. Likewise, the outlet conduit 708 may have an outlet 712 (discharge) for removal of liquid elemental sulfur. The depicted outlets 710, 712 are a representation. The reactor 700 and/or portions of the outlet conduit 708 could be arranged in a vertical configuration to more facilitate removal of the sulfur via gravity. In implementations, the inlet conduit 704 (e.g., conveying natural gas 104 flowing from a wellhead) to the DBD reactor 700 and the outlet conduit 708 (e.g., conveying the treated natural gas 108 to a user) may be carbon steel or stainless steel, depending on the composition of the natural gas. A portion of the outlet conduit 708 between the reactor 700 and a downstream sulfur condenser heat exchanger (if employed) near the reactor 700 may be stainless steel or another metal alloy.

Catalyst is disposed in the reactor 700, such as in the inside volume of the reactor 700 defined by the dielectric material 602. The catalyst may be solid catalyst particles or catalyst pellets, and the like, and may be the types of catalyst discussed. The DBD packed-bed reactor 700 (having the packed bed of catalyst) is a NTP catalytic reactor that performs NTP catalysis. The operation with catalyst in the discharge path (discharge zone) between the electrodes may characterized as in-plasma catalysis.

Lastly, in implementations, the DBD-packed bed reactor 700 may be insulated, or have a metal or plastic outer housing surrounding the grounding electrode 604 and dielectric material 602. The reactor 700 may be insulated for thermal reasons or for protection, or the reactor 700 hosted in a metal surrounding. In addition, the reactor 700 may configured such that water flows around the grounding electrode 604 to control the temperature around (exterior to) the plasma zone.

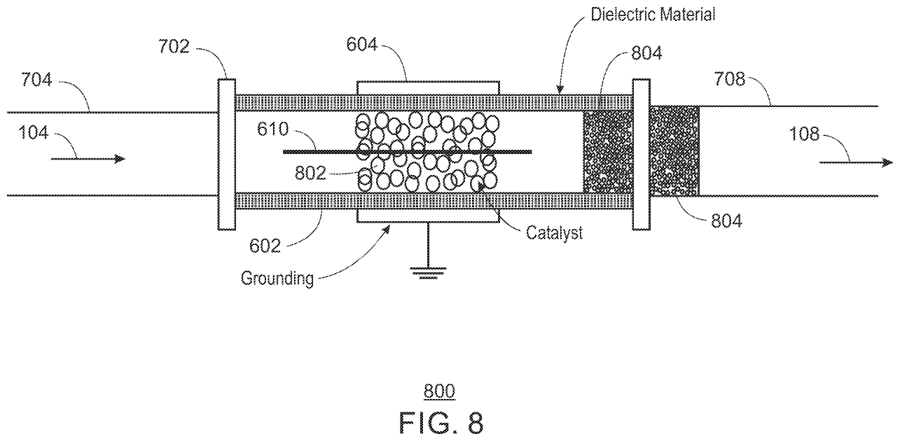

FIG. 8 is a representation of an approximate cross-section of a NTP DBD packed-bed reactor 800 that may be similar to the reactor 700 of FIG. 7. In addition to (or in lieu of) the packed bed catalyst 802, the reactor 800 system may include catalyst 804 (e.g., also as a packed bed). The catalyst 804 may be situated in a discharge (end) portion of the inside volume of the reactor 800 or in the outlet conduit 708, or both. This catalyst 804 may be the same or similar as (or different from) the catalyst 802. As discussed, the catalyst 802, 804 can metal-based catalysts, metal oxide-based catalyst, metal sulfide-based catalysts, or zeolite-based catalysts, or any combinations thereof. These catalysts can be supported or unsupported. The catalyst 802 inside the reactor 800 may provide for in-plasma catalysis because the depicted catalyst 802 is between the low-voltage electrode 604 and the rod electrode 610. In other words, the catalyst 802 is in the discharge zone where the NTP exists in operation. The catalyst 804 (whether in the discharge end portion of the reactor 800 outside of the discharge zone and/or in the outlet conduit 708 downstream of the reactor 800) may provide for post-plasma catalysis. The catalyst 802, 804 may be a single catalyst, bifunctional catalyst, or physical mixture of different catalysts. The catalyst 802, 804 may be utilized to simultaneously catalyze different catalytic reactions (e.g., H₂S splitting, CO₂ dissociation, and CH₄ conversion) and control products selectivity. In embodiments, the DBD packed-bed reactor 800 can be the NTP reactor 112 of FIG. 1.

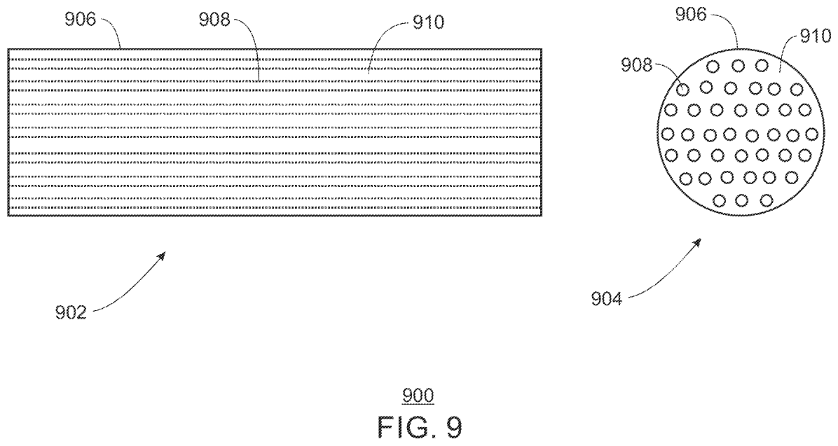

FIG. 9 is a simplified representation of an NTP reactor that is a DBD reactor 900. Depicted are a side view 902 of the reactor 900 and an end view of the reactor 900. The reactor 900 may have cylindrical outer housing or shell 906. The DBD reactor 900 may be multiple DBD cylindrical tubes 908 each similarly configured as in FIGS. 7-8 or otherwise configured to provide for DBD reaction process. Plates or solid material 910 may be situated between the tubes 908 such that the entering natural gas in operation will flow through the tubes 908 and not around the tubes 908. In other words, in implementations, there may be no flow path on the shell side of the tubes 908. Each cylindrical tube 908 may have a high voltage electrode, a low voltage (grounding) electrode, and an intervening dielectric material. In some implementations, the solid material 910 or shell 906 can act as the low voltage (grounding) electrode. Electricity at high voltage (e.g., 1-50 kV) may be supplied to each tube 908. Catalyst for NTP catalysis can be disposed in the tubes 908. In operation, natural gas may enter the tubes 908 at one axial end of the reactor 900 and exist as flowing plasma (NTP) through the tubes 908. Treated natural gas may discharge from the tubes 908 at the other axial end of the reactor 900. Lastly, the DBD reactor 900 may have a vertical orientation to facilitate removal of liquid elemental sulfur from the reactor 900.

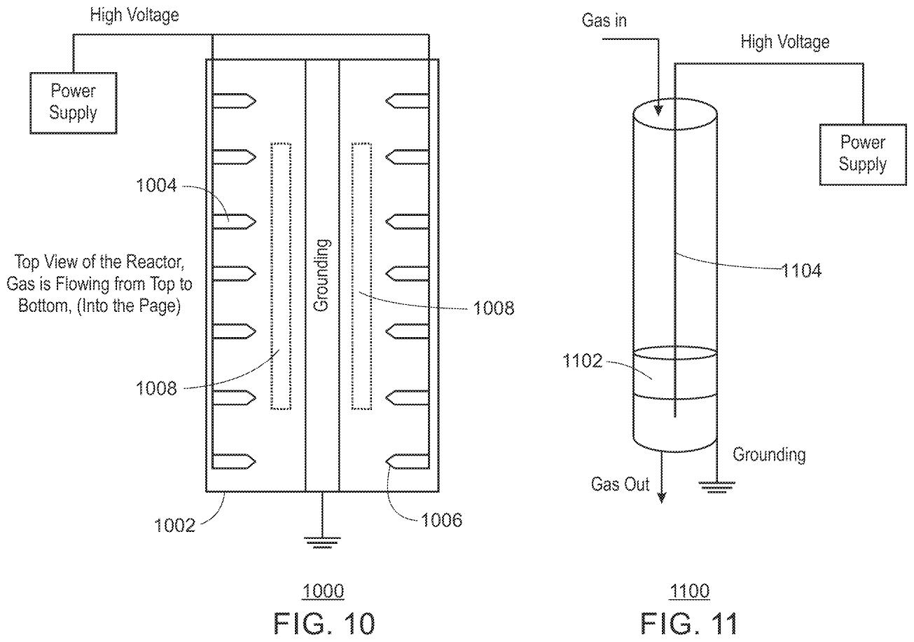

FIG. 10 is a NTP corona discharge reactor 1000 having an enclosure or housing 1002. A high voltage electrode 1004 disposed at interior side portions inside the housing 1002. In operation, electricity at high voltage (e.g., 1-50 kV) is provided from a power supply to the high voltage electrode 1004. A grounding (low voltage) electrode as a plate is situated in a center portion of the reactor 1000 in the housing 1002. The geometry of the two electrodes with respect to each other is asymmetric. The high voltage electrode 1004 has multiple relatively sharp points, as indicated by reference numeral 1006. In contrast, the grounding electrode is a generally flat plate. The corona discharge path is between the high voltage electrode 1004 and the grounding electrode.

In implementations, catalyst 1008 for plasma (NTP) catalysis may be disposed in the reactor housing 1002 between the high voltage electrode 1004 and the grounding electrode. Thus, the NTP corona reactor 1000 may be a NTP catalytic reactor. As indicated, the catalyst 1008 in the discharge zone of the NTP corona reactor 1000 (and thus providing for in-plasma catalysis) can be supported or not supported, and can be metal, metal oxide, metal sulfide, or zeolite catalysts, or any combinations thereof. The catalyst 1000 may be a single catalyst, bifunctional catalyst, or physical mixture of different catalysts. In operation, the catalyst may catalyze different catalytic reactions (e.g., H₂S splitting, CO₂ dissociation, and CH₄ conversion) and control products selectivity. The reactor 1000 may be configured such that the natural gas to be treated enters the top portion of the reactor 1000, flows to the bottom portion of the reactor 1000 (into the page with this top view of reactor 1000 depicted), and discharges from the bottom portion of the reactor 1000 as treated natural gas. The natural gas may be in a plasma state (NTP state) in the reactor 1000, and in which the aforementioned reactions R1, R2, R3, and R4 occur in the NTP corona operation (without or without catalyst 1008). In embodiments, the NTP corona reaction can be the NTP reactor 112 of FIG. 1.

FIG. 11 is a NTP corona discharge reactor 1100 having a hollow cylinder (e.g., metal cylinder) as a grounding electrode. A metal rod 1104 in a center portion of the hollow cylinder is a high voltage electrode and is coupled to a power supply. The geometry of the two electrodes (cylinder wall versus metal rod) is asymmetric with respect to each other. In particular, the high voltage electrode 1104 is a small-diameter bar and the grounding electrode is the cylinder wall of a larger-diameter hollow cylinder. The corona discharge path is the annulus between the high voltage electrode 1104 and the grounding electrode. In operation, the natural gas flowing from the wellhead to be treated enters one end of the hollow cylinder and discharges from the other end of the hollow cylinder. In the reactor 1100, the flowing natural gas may transition to gas plasma (NTP) that gives and advances the aforementioned reactions R1, R2, R3, and R4. In implementations, the corona reactor 1100 may be the NTP reactor 112 of FIG. 1. A packed bed of catalyst 1102 (as discussed) for in-plasma catalysis may be situated in the hollow cylinder to further advance (and in some instances facilitate control of) the reactions R1, R2, R3, and R4.

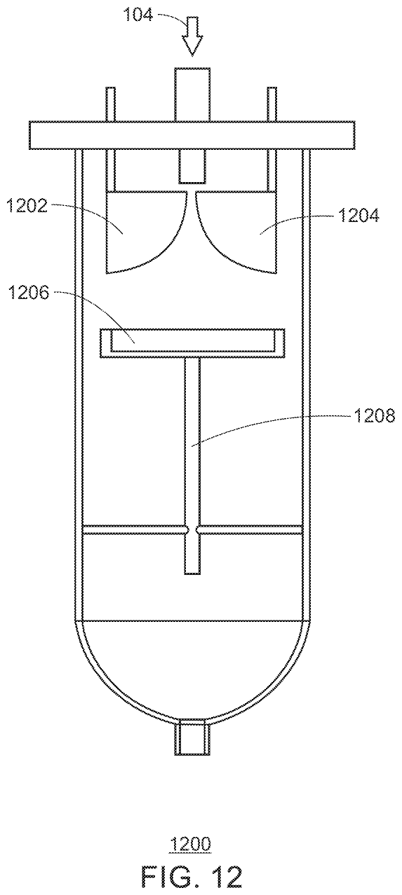

FIG. 12 is a NTP gliding arc discharge reactor 1200 having a high voltage electrode 1202 and a low voltage (grounding) electrode 1204. A power supply (not shown) may supply electricity to the high voltage electrode 1202. In the illustrated embodiment, the inlet for the natural gas 104 flowing from the wellhead is at the top of the reactor 1200. The natural gas discharges as treated natural gas from the bottom of the reactor 1200. The two electrodes 1202, 1204 are diverging with respect to each other along the direction of the flow path of the natural gas. The gliding arc discharges between the electrodes 1202, 1204 may provide for the natural gas to be in a plasma state (NTP state) in the reactor 1200 in which reactions R1, R2, R3, and R4 are advanced via the NTP. A packed bed of catalyst 1206 (as discussed) may be in the reactor 1200 to advance the reactions. In the illustrated example, the packed bed of catalyst 1206 is in a tray situated on (supported by) a tray holder 1208. In implementations, the gliding arc reactor 1200 may be the NTP reactor 112 of FIG. 1.

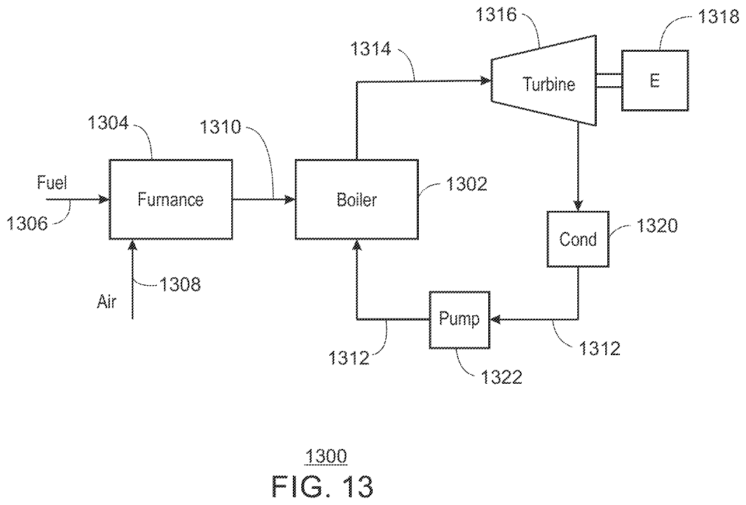

FIG. 13 is a boiler system 1300 including a boiler 1302 for power generation, and may be an example of a user (e.g., 110 of FIG. 1) of produced natural gas (e.g., 108). The system 1300 includes a furnace 1304 that combusts fuel 1306 that may include the treated natural gas 108 (FIG. 1). The furnace 1304, while depicted separate from the boiler 1302 for clarity, may be a boiler furnace as a component of the boiler 1302. The furnace 1304 may be upstream of the boiler 1302, as depicted (e.g., for the boiler 1302 as a heat recovery steam generator (HRSG)). The boiler system 1300, boiler 1302, or the furnace 1304 may be the user 110 (FIG. 1) of the treated natural gas 108 in embodiments. The user 102 may be a power block, power unit, or power plant, and in which the boiler system 1300, boiler 1302, or the furnace 1304 are unit operations 120 (FIG. 1). In the illustrated embodiment, the treated natural gas 108 utilized as fuel 1306 generally has less than 100 ppmv of H₂S so that less H₂S is combusted giving less SO₂ emissions arising from the combustion of the treated gas 108. However, the presence of H₂ and C₂₊ hydrocarbons formed from conversion reactions in the upstream NPT unit 102 (FIG. 1) are generally acceptable (and can be beneficial) for combustion in the furnace 1304.

In operation, the treated natural gas 108 as fuel 1306 is ignited and combusted by burners in the furnace 1304 with the aid of air 1308 provided to the furnace 1304. Hot combustion gas 1310 (furnace exhaust gas or flue gas) from the furnace 1304 heats boiler feedwater 1312 in the boiler 1302 to generate steam 1314. The steam 1314 drives the steam turbine 1316, which in turn drives the steam-turbine generator 1318 that generates electricity. In this illustrated example, the steam turbine 1316 discharges the steam 1314 to the condenser 1320. The condenser 1320 heat exchanger (e.g., shell-and-tube heat exchanger) may employ a cooling medium (e.g., water, such as cooling tower water) to condense the steam. The condenser 1320 heat exchanger may discharge the condensed steam (steam condensate) as boiler feedwater 1312 to the boiler feedwater pump 1322 (e.g., centrifugal pump) that provides motive force for flow of boiler feedwater 1312 to the boiler 1302. Fresh boiler feedwater as makeup can be combined with the boiler feedwater 1312 from the condenser 1320.

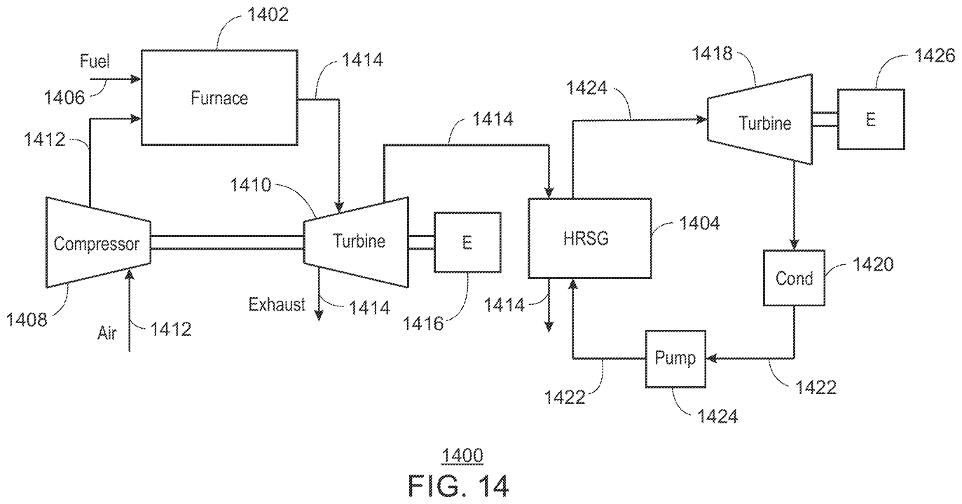

FIG. 14 is a Brayton-Rankine combined cycle 1400 that may be a user 110 of the treated natural gas 108 for power generation. The furnace 1402 may a user 110 of treated natural gas 108 to give power generation. The HRSG 1404 may be labeled as a boiler. The treated natural gas 108 may be fed (introduced) as fuel 1406 to the furnace 1402. The combined cycle 1400 combines the Brayton (gas turbine) and Rankine (steam turbine) thermodynamic cycles. The gas turbine (Brayton cycle) can be driven by combustion. The steam turbine (Rankine cycle) can be driven by steam generated with exhaust waste of the Brayton cycle combustion. The combined cycle 1400 may be characterized as a power plant, a unit of power plant, or a power block.

The Brayton portion of the Brayton-Rankine combined cycle 1400 may include an air compressor 1408, the furnace 1402, and gas turbine 1410. In operation, air 1412 is provided to the compressor 1408 (e.g., a mechanical compressor). The compressor 1408 discharges the air 1412 as compressed to the furnace 1402. The fuel 1406 to be combusted is also fed to the furnace 1402. The combustion gas 1414 discharged from the furnace 1402 drives the gas turbine 1410. In turn, the gas turbine 1410 drives the compressor 1408 and a gas-turbine generator 1416 that generates electricity. A portion of the combustion gas 1414 may discharge from the gas turbine 1410 as exhaust. A portion of the combustion gas 1414 may discharge to the HRSG 1404 in the Rankine cycle part of the combined cycle 1400.

The Rankine portion of the Brayton-Rankine combined cycle 500 may include the HRSG 1404, the steam turbine 1418, and the condenser 1420 (heat exchanger). In operation, the HRSG 1404 receives the combustion gas 1414 and transfers heat from the combustion gas 1414 to boiler feedwater 1422 to vaporize the boiler feedwater 1422 into steam 1424. The HRSG 1404 may discharge the combustion gas 1414, for example, to a flue stack. The HRSG 1414 discharges steam 1424 (e.g., superheated) to drive the steam turbine 1418, which in turn drives the steam-turbine generator 1426 that generates electricity. The steam turbine 1418 discharges the steam 1424 to the condenser 1420. The condenser 1420 heat exchanger (e.g., shell-and-tube heat exchanger) may employ a cooling medium (e.g., water, such as cooling tower water) to condense the steam. The condenser 1420 heat exchanger may discharge the condensed steam (steam condensate) as boiler feedwater 1422 to the boiler feedwater pump 1424.

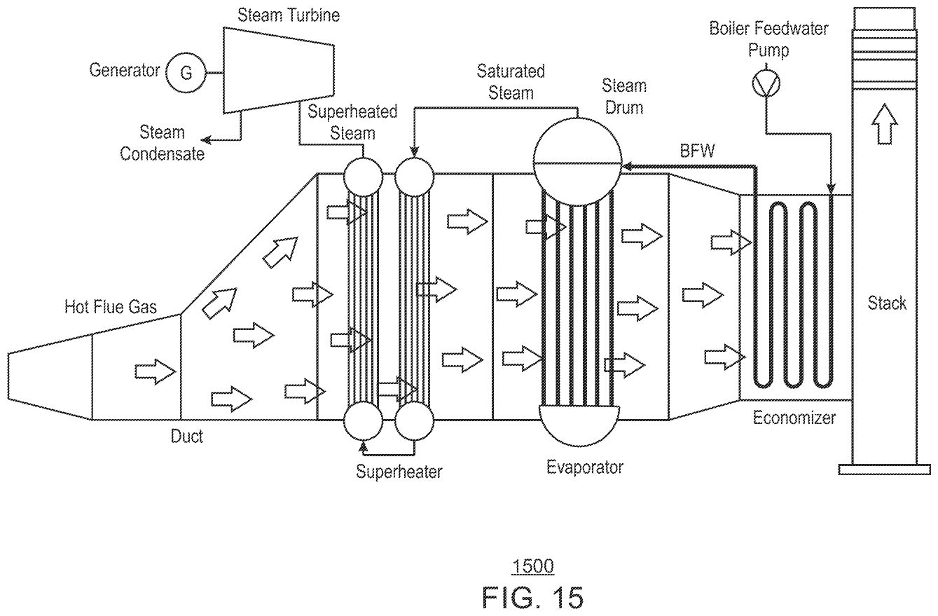

FIG. 15 is an example of an HRSG 1500 that may be analogous to the HRSG 1404 of FIG. 14. The combustion gas (as hot flue gas) that discharges from a furnace (that combusts the treated natural gas 108) and flows through the HRSG 1500 as a heating medium. In the illustrated example, combustion gas (hot flue gas) is received at the front end of the HRSG 1500 from the furnace. For the HRSG 1500, the flue gas flows across the superheater, the evaporator, and the economizer in that order, and discharges through a stack (e.g., flue gas stack) to the environment in the illustrated embodiment. The flue gas may be treated at the stack discharge portion prior to discharge. The H₂S in the treated natural gas 108 may be little or none (e.g., less than 100 ppmv) so that SO₂ emissions in the flue gas discharged to the environment from the flue gas stack does not have significant amounts of SO₂.

A boiler feedwater pump is depicted as providing boiler feedwater to the tubes of the economizer of the HRSG 1500. The boiler feedwater as heated by the economizer flows to the steam drum of the evaporator that vaporizes the liquid boiler feedwater giving saturated steam. The evaporator discharges the saturated steam to the superheater that superheats the steam. In the illustrated implementation, the superheater discharges the superheated steam to a steam turbine, as might be implemented with a combined cycle. The superheated steam drives the steam turbine to generated electricity via a generator coupled to the steam turbine. The superheated steam is condensed via the steam turbine and/or via a downstream condenser heat exchanger to give steam condensate.

Thus, the HRSG 1500 recovers heat from the furnace combustion gas to heat boiler feedwater to produce steam. The produced steam may be, for example, utilized in a process (e.g., cogeneration) or utilized to drive a steam turbine (e.g., in a combined cycle) as depicted, and the like. The HRSG 1500 may overall be called a heat exchanger or a boiler. The HRSG 1500 may generally be a vessel(s) having heat exchangers and in which the boiler feedwater flows through tubes and combustion gas flows through the vessel around the exterior of the tubes. Heat transfer occurs from the combustion gas outside of the tubes through the tube wall to the boiler feedwater in the tubes. In the heat exchange, the boiler feedwater is heated and the combustion gas is cooled. The combustion gas (flue gas) is provided to the HRSG 1500 as a heating medium. Again, the combustion gas is from a furnace that burns fuel (including treated natural gas 108) in the presence of air to give the combustion gas.

The HRSG 1500 includes the economizer, evaporator, and superheater. Each of these three may be labeled as a heat exchanger. The boiler feedwater and the combustion gas may generally flow in a counter current flow with respect to each other through the HRSG 1500. The boiler feedwater is provided to the economizer that heats the boiler feedwater with the combustion gas. The economizer may be, for example, of vertical design or horizontal design. While the economizer may be of a shell-and-tube type with the vessel (e.g., duct) essentially as a shell, the economizer in an HRSG 1500 may include fins or finned tubes. In operation, the economizer may heat the boiler feedwater but typically not above the boiling point of the boiler feedwater. The heated boiler feedwater may flow from the economizer to the evaporator of the HRSG 1500. Again, the flow of the boiler feedwater is typically counter current with the combustion gas (heating medium). The evaporator is a heat exchanger that converts the liquid boiler feedwater into steam that may be saturated steam. The evaporator may be called a steam generator or a boiler. The evaporator may be a heat exchanger having tubes in which the boiler feedwater flows through the tubes. The HRSG 1500 vessel (e.g., duct, housing, pressure vessel, etc.) or other vessel may enclose the evaporator tubes. The combustion gas may flow in the evaporator through the vessel around the tubes. In the evaporator, the boiler feedwater is heated with the combustion gas to evaporate the boiler feedwater into steam. Steam discharges from the evaporator. A steam drum may be associated with (or included as a component of) the evaporator. The upstream boiler feedwater as heated by the economizer may be fed from the economizer to the steam drum as feed to the evaporator. The steam (e.g., saturated) may discharge from the steam drum as discharge from the evaporator to the superheater. The superheater may be a heat exchanger that heats the entering steam to increase the steam to above its saturation temperature to discharge the steam as superheated. In other words, the superheater as a heat exchanger may receive saturated steam from the evaporator and discharge superheated steam. The superheater may heat the steam with the combustion gas. The superheater may have tubes in which in operation, the steam is inside the tubes. Heat transfer in the superheater may occur from the combustion gas on the exterior side of the tubes through the tube wall to the steam in the tubes. The superheater may discharge the superheated steam to drive a steam turbine (e.g., to generate electricity in a combined cycle) or for other applications.

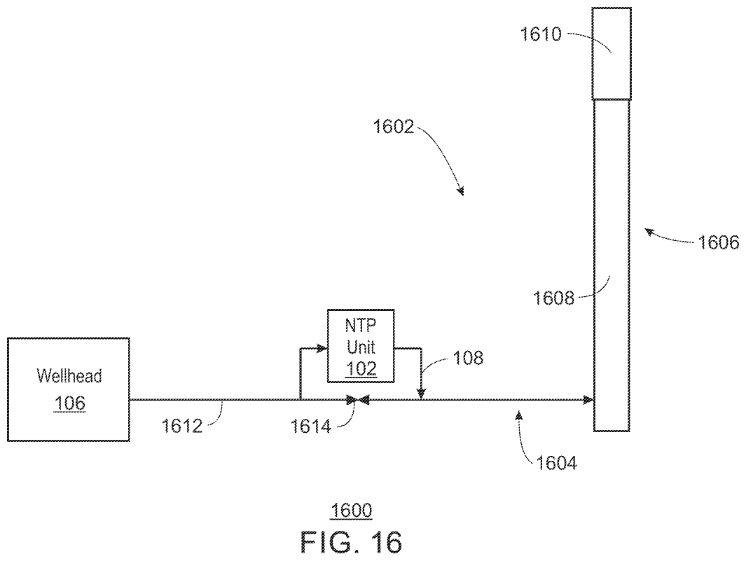

FIG. 16 is a well site 1600 having a wellhead 106 and a flare system 1602. The wellhead 106 may be coupled to a wellbore formed in a subterranean formation, as discussed with respect to FIG. 1. The natural gas in the subterranean formation (that may be produced through the wellbore and the wellhead 106) can be sour natural gas.

The flare system 1602 includes a flare header conduit 1604 and a flare 1606 having a flare stack 1608 (which may be called a riser) and a flare tip 1610. The flare system 1602 can be a user 110 (FIG. 1) of the treated natural gas 108. The flare 1606 can be a unit operation 120 (FIG. 1). In some implementations, the plasma catalytic unit treats fluid discharges or purges from the wellhead to the flare 1606, such as during well testing or maintenance activities, to reduce SO₂ emissions discharged from the flare 1606. (See, for example, FIG. 4).

The flare stack 1608 and the flare tip 1610 may each be cylindrical conduit or conduit-like structure. The flare tip 1610 is coupled to the flare stack 1610, for example, by a hammer union fitting or threaded connection.

In operation, the flare stack 1608 receives produced natural gas (which may be purges) through the flare header 1604 from the wellhead 106. The flare tip 1610 discharges and ignites the produced natural gas, and therefore combusts the produced natural gas as discharged for disposal.

The natural gas being sour natural gas (e.g., having at least 1 vol % of H₂S) is problematic in giving SO₂ emissions to the environment in the combustion of the natural gas at the flare tip 1610. Therefore, embodiments herein provide for a NTP unit 102 (e.g., as in FIG. 1) disposed at the well site 1600. In implementations, the NTP unit 102 can be a mobile unit, as discussed. The natural gas 1612 (e.g., a purge during well testing) discharged from the wellhead 106 (which may be analogous to the natural gas 104 of FIG. 1) is diverted from the flare header 1604 (as represented by the symbol 1614 of a closed valve) through the NTP unit 102. The NTP unit 102 treats the natural gas 1612 to remove H₂S and discharges treated natural gas 108 having, for example, less than 100 ppmv of H₂S to the flare header 1604. Thus, the raw natural gas 1612 is diverted through the NTP unit 102 and introduced (or re-introduced) as treated natural gas 108 into the flare header 1604 for transport (conveyance) to the flare 1606. The treated natural gas 108 may enter an inlet portion of the flare stack 1608 and flow through the flare stack 1608 to the flare tip 1610.

While the produced natural gas 1612 (e.g., sour natural gas) may be associated with production flaring, the produced natural gas 1612 may discharge from the wellhead 106 associated with cleaning or maintenance of the well. Various equipment associated with the wellhead 106 may discharge process fluid through subheaders to the flare header 1604 conduit that conveys the produced fluid to the flare 1606. The continuous flow or purges (e.g., intermittent purges) of natural gas 1612 from the wellhead to the flare system 1602 may occur during drilling of the subterranean formation, application of completion fluids to the wellbore, workover operations of the wellbore, flowback operations, well testing, and so forth. Flowback operations may occur when the well is initially opened, during initial well cleanup and the early stage of production, and to remove fluids introduced to the well. Flowback operations may be conducted for reservoir stimulation and removal of unwanted solids that were introduce by drilling fluids that might cause erosion to production line, and so forth. The present techniques may accommodate targeting flowback operations associated with new wells and with wells that had a recent workover.

Lastly, a vessel(s) (not shown) may be disposed along the flare header 1604. A separator vessel (e.g., three-phase separator having horizontal or vertical orientation) may be employed at the wellhead 106 to separate produced well fluid into gas, oil, and water phases. In certain implementations, a knock-out drum (also called knock-out pot) that is a vessel downstream of the separator may be disposed along the flare header 1604 transporting the produced fluid to the flare stack 1608. A knock-out drum (e.g., situated adjacent to or near the base of the flare 1606) may recover liquid (e.g., typically water) from the produced fluid. At a well site (e.g., an oil well at a remote area), a knock-out drum may be only strategically employed if there is high-water content in the produced fluid 1612, such as with problematic operation of the upstream three-phase separator or other reasons. In implementations, a knock-out drum is not included or can be bypassed.

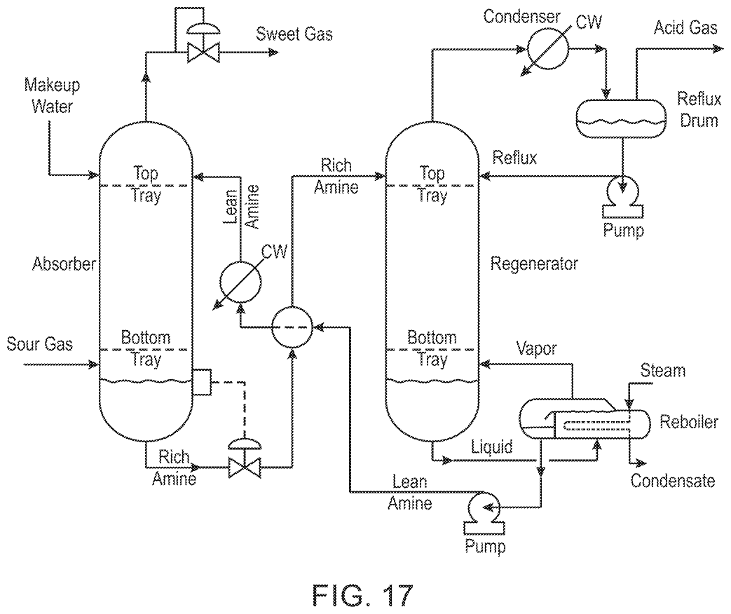

FIG. 17 is an example of system (gas sweetening system) that implements amine gas treating, also known as amine scrubbing, gas sweetening, and acid gas removal. The system may be called a gas sweetening unit and that may be a user 110 (FIG. 1) of the treated natural gas 108 (FIG. 1). (See also, for example, FIG. 3). In implementations, the treated natural gas 108 may be fed to the gas sweetening unit when the NTP unit 102 (FIG. 1) does not convert all of the H₂S in the natural gas 104 that enters the NTP unit 102. For instance, the treated natural gas 108 may have 5 vol % H₂S, whereas the natural gas 104 had 10 vol % H₂S. Yet, this example reduction of half of the H₂S in the natural gas is beneficial in reducing the load on the gas sweetening unit.

The system depicted in FIG. 17 employs an aqueous solution of an alkylamine(s) (referred to as amine) to remove H₂S and CO₂ from gases, such as the treated natural gas 108 (FIG. 1). Gas sweetening units are utilized in natural gas processing plants, petroleum refineries, petrochemical plants, and other industries. In embodiments herein, a natural gas processing plant may be the user 110 (FIG. 1) and the gas sweetening unit may be unit operation(s) 120 (FIG. 1) of the natural gas processing plant. The sweetening unit may be the user 110 and the absorber column may be a unit operation 120 of the gas sweetening unit.

Amines utilized in the gas sweetening unit may include diethanolamine (DEA), monoethanolamine (MEA), methyldiethanolamine (MDEA), diisopropanolamine (DIPA), and aminoethoxyethanol (Diglycolamine) (DGA). Amines commonly employed are the alkanolamines DEA, MEA, and MDEA.

The gas (e.g., natural gas) having H₂S (and CO₂) is treated in the sweetening unit to remove the H₂S (and the CO₂). The chemistry in the amine treating may vary in particular with the amine. As an example, for MEA denoted as RNH₂, the acid-base reaction involves protonation of the amine electron pair to form a positively charged ammonium group RNH₃⁺, and which can be represented by RNH₂+H₂S [symbol] RNH₃⁺+HS⁻ and RNH₂+H₂CO₃ [symbol] RNH₃⁺+HCO₃⁻. The resulting dissociated and ionized species being more soluble in solution are scrubbed by the amine solution and thus removed from the gas phase. At the outlet of the amine scrubber, the gas as sweetened is thus depleted in H₂S and CO₂.

The system depicted in FIG. 17 is only an example a typical amine gas treating process and includes an absorber column and a regenerator distillation column. The sour gas (e.g., treated natural gas 108 having at least 10 vol % acid gas) enters a bottom portion of the absorber column (vessel) and flows upward through the absorber column. An aqueous solution of amine enters a top portion of the absorber column and flows downward through the absorber column in a countercurrent direction with respect to the sour gas flowing upward. This amine solution that enters the absorber column may be labeled as lean amine in having little or no acid gas. The absorber column may have trays as indicated, or may have packing, to provide surface area for contact of the lean amine with the sour gas and thus give mass transfer stages for absorption of acid gas from the sour gas into the lean amine. Sweet gas having little or no acid gas discharges overhead from the absorber column for further processing in the natural gas processing plant. Rich amine (rich in acid gas by having the acid gas absorbed from the sour gas) discharges from a bottom portion of the absorber column. In the illustrated example, a liquid level of the rich amine solution may be maintained in the bottom portion of the absorber column via a control valve and a level sensor.

The rich amine may flow to the regenerator (regenerator distillation column) that removes the acid gas from the rich amine to discharge the lean amine from a bottom portion of the regenerator. The removed acid gas may discharge overhead from the regenerator and be partially condensed. Reflux may be sent via a reflux drum (vessel) and a reflux pump (e.g., centrifugal pump) to the regenerator. Acid gas (H₂S and CO₂) may discharge from the system as gas from the vapor space of the reflux drum. The acid gas may be sent, for instance, to an SRU (e.g., Claus process system) in which the H₂S is converted to elemental sulfur. The lean amine discharges from a bottom portion of the regenerator. The regenerator includes a steam reboiler to vaporize a portion of the lean amine for return to the regenerator. The liquid amine is pumped through a cross exchanger (cooled by the rich amine) and a cooler heat exchanger (e.g., cooling water is cooling medium) for supply to the absorber column.

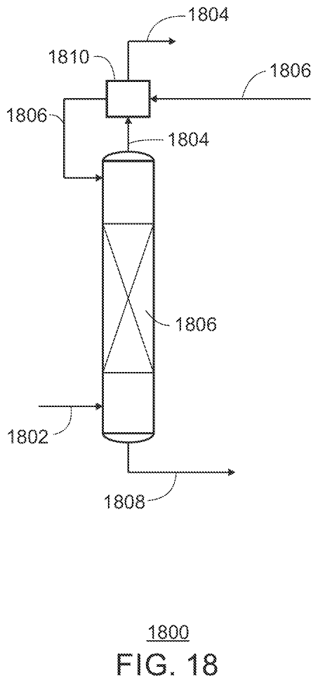

FIG. 18 is a contactor column 1800 (absorber column) that dehydrates natural gas 1802 with a liquid desiccant, such as glycol. The glycol may be triethylene glycol (TEG). The contactor column 1800 may be part of a natural gas dehydration system in a natural gas processing plant. The contactor column 1800 may receive natural gas from a gas sweetening unit if the further upstream natural gas (e.g., treated natural gas 108) had a significant amount of H₂S, or may receive the natural gas (e.g., treated natural gas 108) not processed in a gas sweetening unit if the upstream natural gas (e.g., treated natural gas 108) did not have a significant amount of H₂S.

In implementations, the natural gas processing plant or the natural gas dehydration system may be the user 110 of FIG. 1, and the contactor column 1800 as a unit operation 120 of FIG. 1. In some implementations, the natural gas 1802 entering the contactor column may be treated natural gas 108 (FIG. 0.1) in instances the treated natural gas 108 has little or no acid gas (and thus bypasses, for example, any existing sweetening unit). Such may occur, for example, when the NTP catalytic unit 102 removes most or all of the acid gas from the wellhead-discharged natural gas 104. In other implementations, the treated natural gas 108 has acid gas and is treated in a sweetening unit, and then processed in the contactor column 1800. Other configurations are applicable. The dehydration system having the contactor column 1800 may be employed when the natural gas has moisture (water).

In operation, the contactor column 1800 receives wet natural gas 1802, which may include the treated natural gas 108 (FIG. 1) and contacts the natural gas 1802 with TEG as liquid desiccant for the TEG to absorb water from the natural gas 1802. A TEG regeneration system (not shown) regenerates (removes water from) the TEG (rich TEG discharged from the column 1800) to give dried (lean) TEG for re-use as the absorbing TEG in the contactor column 1800.

The contactor column 1800 is a vessel that is an absorption column. The contactor column 1800 employs the TEG to remove (absorb) water from the natural gas 1802 to give the dehydrated (dried) natural gas 1804. The contactor column 1800 may also be called a contactor tower, absorber, absorber column, absorption column, dehydrator, dehydrator column, glycol contactor, glycol contactor column, TEG contactor column, and so forth. The contactor column 1800 utilizes the TEG to dehydrate the natural gas 1802 to give dehydrated natural gas 1804 as product for distribution or further processing in the natural gas processing plant. As denoted by reference numeral 1806, the contactor column 1800 may include column trays (e.g., bubble cap traps, sieve trays, etc.) or packing (e.g., random packing or structured packing) to provide mass-transfer stages and surface area for absorption of water by the TEG from the natural gas.

The natural gas 1802 entering the contactor column 1800 may flow upward through the contactor column 1800. The contactor column 1800 may receive lean TEG 1806 into an upper portion of the contactor column 1800. The term “lean” means that the TEG is lean in water and may have less than 1 wt % water. The contactor column 1800 may receive the lean TEG from a TEG regeneration still column (not shown). The lean TEG 1806 entering the contactor column 1800 may flow downward through the contactor column 1800. Thus, the natural gas and TEG may be in a counter current flow with respect to each other in the contactor column 1800 for the absorption of water from the natural gas into the TEG. The dehydrated natural gas 1804 may discharge overhead from the contactor column 1800 through a discharge conduit. In implementations, the dehydrated natural gas 1804 may have a concentration of water less than 7 pounds per million standard cubic feet. Rich TEG 1808 may discharge through a discharge conduit from a bottom portion of the contactor column 1800. The term “rich” means that the TEG is rich in water, such as saturated (or approaching saturation) in water. The rich TEG 1800 may have a concentration of water of at least 2 weight percent (wt %), such as in a range of 2 wt % to 6 wt %. The rich TEG may be sent to the regeneration system for removal of water to give lean TEG for return to the contactor column 1800. Lastly, prior to the lean TEG 1806 entering the contactor column 1800, the lean TEG 1806 may be cooled in a heat exchanger 1810 (cross-exchanger) with the product (dehydrated) natural gas 1804 discharging overhead from the contactor column 1800 as the cooling medium. The heat exchanger 1810 may be a shell-and-tube heat exchanger, a plate-fin heat exchanger, a jacketed-pipe heat exchanger, etc.

Embodiments relate to a method and system for H₂, CO, S, and hydrocarbons production from sour natural gas streams at relatively low temperatures. Embodiments may include a low-temperature (e.g., less than 250° C.) method and system to produce H₂, CO, S, and hydrocarbons from gas mixtures including H₂S, CO₂, and CH₄. Such may advance development of natural gas reservoirs having high acid gas content. Certain implementations can be employed to monetize sour natural-gas reservoirs as an innovative cost-effective alternative to typical gas sweetening and sulfur recovery units. Simultaneously, value-added products, such as H₂, CO, and C₂₊ hydrocarbons may be generated. The technology can be utilized as a mobile H₂S abatement and avoidance of SO₂ emission during well operations (e.g., drilling, well testing, workover), where gas is flared.

Embodiments may avoid the relatively high cost associated with handling natural gas streams having high H₂S and CO₂ content employing typical gas sweetening and sulfur recovery units. By utilizing embodiments of the present techniques as a pre-treatment, existing conventional gas sweetening units and SRU can process natural gas sourced as sour natural gas that has not been developed. Again, the techniques can also addresses problems of SO₂ emissions during well operations including temporary well operations.

In utilizing the some of the disclose embodiments, the H₂S (and CO₂) in the natural gas can be substantially completely converted. Therefore, typical gas sweetening and sulfur recovery units may be eliminated or bypassed in some implementations, reducing operating costs (e.g., utilizing less energy). In certain embodiments, the H₂S (and CO₂) in the natural gas can be partially converted, which may reduce the load and operating cost of gas sweetening units.

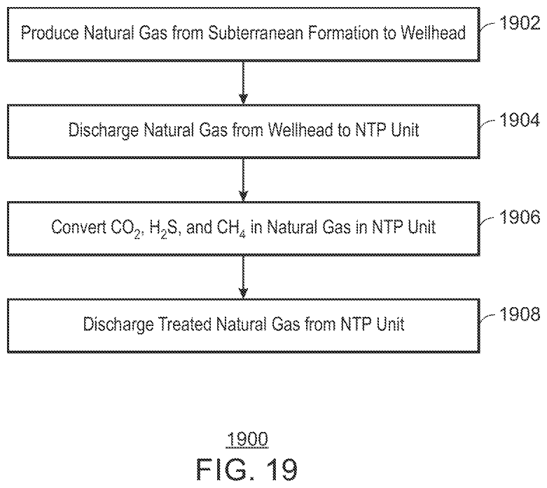

FIG. 19 is a method 1900 of treating sour natural gas. The method may be a continuous operation. In other words, the actions of blocks 1902 to 1908 may collectively in concert be a continuous operation in a continuous system in implementations.

At block 1902, the method includes producing natural gas from a subterranean formation through a wellbore to a wellhead. In certain implementations, the natural gas has at least 20 vol % of acid gas including H₂S and CO₂.

At block 1904, the method includes discharging the natural gas from the wellhead via an inlet conduit to a NTP unit having a NTP reactor and a catalyst. The NTP unit may be at least indirectly coupled to (e.g., in fluid communication with) the wellhead system via the inlet pipe. Configurations other than the NTP unit being coupled to the wellhead via an inlet conduit are applicable.

The method may include exciting, via the NTP reactor, molecules in the natural gas into a NTP state in the NTP reactor to dissociate at least some of the molecules. The NTP reactor may be, for example, dielectric barrier discharge, corona discharge, pulsed corona discharge, gliding arc discharge, or arc discharge. In implementations, the catalyst is disposed in the NTP reactor or in a conduit downstream of the NTP reactor, or both. The catalyst may be metal-based, metal oxide-based, metal sulfide-based, or zeolite-based, or any combinations thereof. In some implementations, the NTP reactor includes a dielectric barrier discharge (DBD) having two electrodes, wherein voltage between the two electrodes is greater than breakdown voltage of the natural gas flowing between the two electrodes, and wherein at least a portion of the catalyst is disposed between the two electrodes.

At block 1906, the method includes converting, via the NTP unit, CO₂ and H₂S in the natural gas into CO, H₂, heavy hydrocarbon (C₂₊) and elemental sulfur (S). The elemental sulfur is removed as liquid elemental sulfur to give treated natural gas. In implementations, the natural gas has at least 5-10 vol % of H₂S, wherein at least half of the H₂S in the natural gas is converted via the NTP unit into elemental sulfur. In other implementations, the natural gas has less than 5-10 vol % of H₂S or less than 1 vol % of H₂S, and/or the NTP unit converts less than half of the H₂S. The removing of the elemental sulfur may involve condensing elemental sulfur gas in a condenser heat exchanger in the NTP catalytic unit downstream of the NTP reactor. The degree of conversion of the H₂S (the percent of H₂S converted) specified, configured, applied, or implemented may be decided or determined by economics or other factors. In some cases, the economics or other considerations of the application may lead to it being beneficial to convert most or all of the H₂S. In other cases, the economics or additional considerations may lead to the application being beneficial to convert only a portion of the H₂S and to rely, for example, on a downstream amine unit to remove the remaining H₂S. A wide range of conversions of H₂S are applicable with the present techniques including in view of overall process economics and/or other issues. With that said, the present NTP treating of natural gas having high H₂S or high acid gas are significant embodiments, for example, in that the present NTP catalytic unit techniques can generally readily treat such problematic streams in contrast to other technologies.

The converting of the CO₂ may include converting, via the NTP unit, CO₂ in the natural gas into CO and oxygen (O₂) gas by the disassociation reaction 2CO₂→2CO+O₂. The converting of the H₂S into elemental sulfur may include converting, via the NTP unit, H₂S into elemental sulfur and H₂ gas by dissociation reaction H₂S→H₂+S. The converting of the CO₂ may include converting, via the NTP unit, CO₂ in the natural gas into CO and H₂O by the hydrogenation reaction CO₂+H₂→CO+H₂O, wherein a source of H₂ for the hydrogenation reaction includes H₂ formed in the dissociation reaction of H₂S. The method may include converting, via the NTP unit, CH₄ in the natural gas received into H₂ and C₂₊ hydrocarbons. In implementations, the natural gas received has at least 55 vol % of CH₄, and wherein less than half of the methane CH₄ in the natural gas is converted. The natural gas can have less than 55 vol % of CH₄. Sub-quality natural gas can have less than 55 vol % of CH₄, and can have, for example, high acid gas and high N₂ content. In implementations, the converting via the NTP unit (of the CH₄, the H₂S, and the CO₂) occurs at less than 200° C., less than 250° C., or less than 300° C., and/or greater than 125° C., 150° C., or 175° C.

At block 1908, the method includes discharging the treated natural gas from the NTP unit via an outlet conduit (discharge conduit). In implementations, the treated natural gas may be discharge from the NTP unit via the outlet conduit to a furnace to combust the treated natural gas for power generation, or to a flare system having a flare to combust the treated natural gas for disposal of the treated natural gas, or to a natural gas processing plant having a vessel (e.g., amine absorber column, glycol contactor column, etc.) to process the treated natural gas for provision of natural gas as product.

The method may include discharging the treated natural gas from the NTP unit (NTP catalytic unit) through a discharge conduit to a boiler having or associated with a furnace. In this implementation, the treated natural gas may have less than 100 ppmv of H₂S. The method may include combusting the treated natural gas in the furnace to generate steam via the boiler. The steam may be utilized as a heating medium or drive a turbine to generate electricity, or a combination thereof.

The method may include discharging the treated natural gas from the NTP catalytic unit through a discharge conduit to a flare system having a flare, wherein the NTP catalytic unit and the flare system are disposed at a well site having the wellhead. The method may include combusting the treated natural gas via the flare for disposal of the treated natural gas, wherein the treated natural gas has less than 100 ppmv of H₂S.

The method may include discharging the treated natural gas from the NTP catalytic unit through a discharge conduit to a natural gas processing plant having a gas sweetening unit including an amine absorber column to scrub acid gas from the treated natural gas. In implementations, the treated natural gas entering the gas sweetening unit has at least 1 vol % of H₂S. In other implementations, the treated natural gas entering the sweetening unit may have less than 1 vol % of H₂S such as less than 100 ppmv of H₂S or no H₂S, and the gas sweeting unit employed, for example, to remove CO₂ to meet the sales gas specification.

Lastly, while certain embodiments have focused on treating natural gas (or a CH₄ stream) having at least 20 vol % acid gas, at least 10% H₂S, and/or at least 10% CO₂, it should be emphasized that embodiments of the present techniques are not limited to these numerical values. The stream (e.g., CH₄ stream or natural gas stream) to be treated via the present NTP catalytic unit in implementations can have significantly less than 20 vol % acid gas, little or no H₂S, and/or little or no CO₂. First, for implementations, there generally is no fundamental technical reason (e.g., with respect to the NTP unit) that limits the processing in embodiments to only streams with high acid gas. Second, in implementations, the applying of the present techniques can be a case-by-case consideration. For instance, economics may facilitate deciding the application. The disclosed techniques can be utilized for natural gas with low acid gas content with such depending, for example, on economics and the particular case/conditions (e.g., composition, flow rate, location, etc.) The disclosed process can be applied for natural gas having a wide range of acid gas concentrations. Again, such may be a case-by-case evaluation depending on economics or other factors of the implementation. The natural gas to be treated may have less than 15 vol % acid gas, less than 5 vol % acid gas, etc., and with embodiments of the present methods and NTP catalytic unit feasible or advantageous to employ, for example, in addition to (or in lieu of) a downstream amine process or in addition to other downstream users of the treated natural gas.

A number of implementations have been described. Nevertheless, it will be understood that various modifications may be made without departing from the spirit and scope of the disclosure.

1. A method of treating sour natural gas, comprising:
producing natural gas from a subterranean formation through a wellbore to a wellhead;
discharging the natural gas from the wellhead via an inlet conduit to a nonthermal plasma (NTP) unit comprising a NTP reactor and a catalyst;
converting, via the NTP unit, carbon dioxide (CO₂) in the natural gas into carbon monoxide (CO);
converting, via the NTP unit, hydrogen sulfide (H₂S) in the natural gas into elemental sulfur (S) and hydrogen (H₂), and removing the elemental sulfur as liquid elemental sulfur to give treated natural gas; and
discharging the treated natural gas from the NTP unit via an outlet conduit.

2. The method of claim 1, comprising converting, via the NTP unit, methane (CH₄) in the natural gas into hydrogen (H₂) and hydrocarbons having at least two carbon atoms, wherein converting, via the NTP unit, the CH₄, the H₂S and the CO₂ occurs at less than 250° C., and wherein less than half of the CH₄ in the natural gas is converted.

3. The method of claim 1, comprising exciting, via the NTP reactor, molecules in the natural gas into a NTP state in the NTP reactor to dissociate at least some of the molecules, wherein the NTP reactor comprises dielectric barrier discharge, corona discharge, pulsed corona discharge, gliding arc discharge, or arc discharge, wherein the natural gas comprises at least 5 vol % of H₂S.

4. The method of claim 1, wherein the catalyst is disposed in the NTP reactor or in a conduit downstream of the NTP reactor, or both, wherein the catalyst is metal-based, metal oxide-based, metal sulfide-based, or zeolite-based, or any combinations thereof, and wherein the natural gas comprises at least 20 vol % of acid gas comprising H₂S and carbon dioxide (CO₂).

5. The method of claim 1, wherein the NTP reactor comprises a dielectric barrier discharge (DBD) comprising two electrodes, wherein voltage between the two electrodes is greater than breakdown voltage of the natural gas flowing between the two electrodes, and wherein at least a portion of the catalyst is disposed between the two electrodes.

6. The method of claim 1, wherein converting the CO₂ comprises converting, via the NTP unit, CO₂ in the natural gas into CO and oxygen (O₂) gas by disassociation reaction 2CO₂→2CO+O₂, and wherein converting the H₂S into elemental sulfur comprises converting, via the NTP unit, H₂S into elemental sulfur and hydrogen (H₂) gas by dissociation reaction H₂S→H₂+S.

7. The method of claim 6, wherein converting the CO₂ comprises converting, via the NTP unit, CO₂ in the natural gas into CO and water (H₂O) by hydrogenation reaction CO₂+H₂→CO+H₂O, wherein a source of H₂ for the hydrogenation reaction comprises H₂ formed in the dissociation reaction of H₂S.

8. The method of claim 1, wherein discharging the treated natural gas comprises discharging the treated natural gas from the NTP unit via the outlet conduit to a furnace to combust the treated natural gas for power generation, or to a flare system comprising a flare to combust the treated natural gas for disposal of the treated natural gas, or to a natural gas processing plant comprising a vessel to process the treated natural gas for provision of natural gas as product.

9. The method of claim 1, wherein at least half of the H₂S in the natural gas is converted via the NTP unit into elemental sulfur, and wherein discharging the treated natural gas comprises discharging the treated natural gas from the NTP unit via the outlet conduit to a furnace to combust the treated natural gas for power generation or to a flare to combust the treated natural gas for disposal of the treated natural gas.

10. The method of claim 1, wherein less than 80% of the H₂S in the natural gas is converted via the NTP unit into elemental sulfur, and wherein discharging the treated natural gas comprises discharging the treated natural gas from the NTP unit via the outlet conduit to a gas sweetening unit.

11. A method of treating sour natural gas, comprising:
producing natural gas from a subterranean formation through a wellbore and a wellhead to a nonthermal plasma (NTP) catalytic unit comprising a NTP reactor and a catalyst, wherein the natural gas comprises at least 20 volume percent (vol %) of acid gas comprising carbon dioxide (CO₂) and hydrogen sulfide (H₂S);
converting, by the NTP catalytic unit, CO₂ in the natural gas by dissociation reaction of CO₂ into carbon monoxide (CO) and oxygen (O₂);
converting, by the NTP catalytic unit, H₂S in the natural gas by dissociation reaction of H₂S into elemental sulfur (S) and hydrogen (H₂); and
removing the elemental sulfur as liquid elemental sulfur to give treated natural gas comprising less than 10 vol % of acid gas.

12. The method of claim 11, comprising discharging the treated natural gas from the NTP catalytic unit through a discharge conduit to a flare system for disposal, a furnace for power generation, or a natural gas processing plant, wherein removing the elemental sulfur comprises condensing elemental sulfur gas in a condenser heat exchanger in the NTP catalytic unit downstream of the NTP reactor.

13. The method of claim 11, comprising:
discharging the treated natural gas from the NTP catalytic unit through a discharge conduit to a boiler comprising a furnace, wherein the treated natural gas comprises less than 100 part per million by volume (ppmv) of H₂S; and
combusting the treated natural gas in the furnace to generate steam via the boiler, wherein the steam is utilized as a heating medium or to drive a turbine to generate electricity, or a combination thereof.

14. The method of claim 11, comprising:
discharging the treated natural gas from the NTP catalytic unit through a discharge conduit to a flare system comprising a flare, wherein the NTP catalytic unit and the flare system are disposed at a well site comprising the wellhead; and
combusting the treated natural gas via the flare for disposal of the treated natural gas, wherein the treated natural gas comprises less than 100 ppmv of H₂S.

15. The method of claim 11, comprising:
exciting molecules in the natural gas via the NTP reactor, wherein the NTP reactor comprises dielectric barrier discharge, corona discharge, pulsed corona discharge, gliding arc discharge, or arc discharge; and
discharging the treated natural gas from the NTP catalytic unit through a discharge conduit to a natural gas processing plant comprising a gas sweetening unit comprising an amine absorber column to scrub acid gas from the treated natural gas, wherein the treated natural gas entering the gas sweetening unit comprises at least 1 vol % of acid gas.

16. A method of treating sour natural gas, comprising:
producing natural gas from a subterranean formation through a wellhead and through a nonthermal plasma (NTP) system downstream of the wellhead, the NTP system comprising a NTP reactor and a catalyst, wherein the natural gas flows from the wellhead via an inlet conduit to the NTP system;
converting, via the NTP system, carbon dioxide (CO₂) in the natural gas into carbon monoxide (CO) and oxygen (O₂);
converting, via the NTP system, hydrogen sulfide (H₂S) in the natural gas into elemental sulfur (S) and hydrogen (H₂);
removing, via the NTP system, the elemental sulfur from the natural gas to give treated natural gas; and
discharging the treated natural gas from the NTP system via a discharge conduit to a user.

17. The method of claim 16, wherein the user comprises a furnace that combusts the treated natural gas for generating electricity for power generation, a flare system comprising a flare that combusts the treated natural gas for disposal of the treated natural gas, or a natural gas processing plant comprising a vessel that processes the treated natural gas.

18. The method of claim 16, converting, via the NTP system, methane (CH₄) in the natural gas into hydrogen (H₂) and C₂₊ hydrocarbons, wherein the C₂₊ hydrocarbons are hydrocarbons having two or more carbon atoms in each molecule of the hydrocarbons, and wherein an operating temperature of the NTP reactor is less than 200° C.

19. A method of treating sour natural gas, comprising:
discharging natural gas from a wellhead system coupled to a wellbore through which the natural gas is produced from a subterranean formation, wherein the natural gas comprises at least 20 volume percent (vol %) of acid gas;
converting carbon dioxide in the natural gas into carbon monoxide and oxygen via nonthermal plasma (NTP) catalysis in fluid communication with the wellhead system;
converting hydrogen sulfide in the natural gas as received from the wellhead system into elemental sulfur and hydrogen via the NTP catalysis; and
removing the elemental sulfur from the natural gas to discharge treated natural gas to a user, wherein discharging the natural gas from the wellhead system, converting the carbon dioxide and the hydrogen sulfide, and removing the elemental sulfur are collectively a continuous operation.

20. The method of claim 19, comprising converting, via the NTP catalysis, methane in the natural gas into hydrogen and hydrocarbons having two or more carbon atoms, wherein less than half of methane in the natural gas is converted.
